(19) United States
(12) Patent Application Publication
(10) Pub. No.: US 2017/0169793 A1
(43) Pub. Date: Jun. 15, 2017

(54) LUMINANCE COMPENSATING APPARATUS, METHOD OF COMPENSATING LUMINANCE, AND DISPLAY SYSTEM HAVING THE LUMINANCE COMPENSATING APPARATUS

(71) Applicant: Samsung Display Co., Ltd., Yongin-si (KR)

(72) Inventors: Tae-Wook KIM, Cheonan-si (KR); Dong-Jun HAN, Cheonan-si (KR)

(21) Appl. No.: 15/181,267

(22) Filed: Jun. 13, 2016

(30) Foreign Application Priority Data
Dec. 9, 2015 (KR) 10-2015-0175024

(51) Int. Cl. G09G 5/02; G02B 27/01; G09G 5/14

(52) U.S. Cl. CPC G09G 5/026; G09G 5/14; G02B 27/0172; G09G 2320/0233; G09G 2320/0242; G09G 2320/0666

(57) ABSTRACT

A luminance compensating apparatus includes: a color coordinate data receiver; a white luminance data receiver; a luminance divider to divide a first luminance of a first display module from first color coordinate data and first white luminance data, and to divide a second luminance of a second display module from second color coordinate data and second white luminance data; a luminance rate calculator to calculate a rate of the second luminance compared to the first luminance to output a first luminance rate; a target luminance calculator to divide the second luminance by the first luminance rate to output a first target luminance of the second display module; and a luminance compensator to output first luminance compensating data for compensating the second luminance of the second display module from the first target luminance.

### CROSS-REFERENCE TO RELATED APPLICATION

This application claims priority to and the benefit of Korean Patent Application No. 10-2015-0175024, under 35 U.S.C. §119, filed on Dec. 9, 2015 in the Korean Intellectual Property Office (KIPO), the contents of which are incorporated herein by reference in their entirety.

### BACKGROUND

1. Field

One or more aspects of exemplary embodiments of the present inventive concept relate to a luminance compensating apparatus, a method of compensating a luminance using the luminance compensating apparatus, and a display system including the luminance compensating apparatus.

2. Description of the Related Art

A Head Mount Display (HMD) is a display apparatus that may be mounted on a head. The HMD may include a first display module and a second display module corresponding to eyes of a human.

Generally, a display apparatus compensates a luminance of the display apparatus based on a specification thereof. For example, a target luminance of the display apparatus may be about 360 nits, and an error range of about 10% may be allowed. In this case, when a luminance of the display apparatus is about 324 to about 396 nits, the display apparatus may be determined as normal.

However, when a difference between a luminance of the first display module in the HMD and a luminance of the second display module in the HMD is equal to or greater than a critical value, display quality of the HMD may be decreased.

The above information disclosed in this Background section is for enhancement of understanding of the background of the inventive concept, and therefore, it may contain information that does not constitute prior art.

### SUMMARY

One or more exemplary embodiments of the present inventive concept provide a luminance compensating apparatus capable of improving display quality of a display apparatus.

One or more exemplary embodiments of the present inventive concept also provide a method of compensating a luminance using the luminance compensating apparatus.

One or more exemplary embodiments of the present inventive concept also provide a display system including the luminance compensating apparatus.

More particularly, one or more aspects of exemplary embodiments of the present inventive concept relate to a luminance compensating apparatus for compensating a luminance of a display apparatus including two or more display modules, a method of compensating a luminance using the luminance compensating apparatus, and a display system including the luminance compensating apparatus.

According to an exemplary embodiment of the present inventive concept, a luminance compensating apparatus includes: a color coordinate data receiver configured to receive first color coordinate data of a first display module and second color coordinate data of a second display module; a white luminance data receiver configured to receive first white luminance data of the first display module and second white luminance data of the second display module; a luminance divider configured to divide a first luminance of the first display module from the first color coordinate data and the first white luminance data, and to divide a second luminance of the second display module from the second color coordinate data and the second white luminance data; a luminance rate calculator configured to calculate a rate of the second luminance compared to the first luminance to output a first luminance rate; a target luminance calculator configured to divide the second luminance by the first luminance rate to output a first target luminance of the second display module; and a luminance compensator configured to output first luminance compensating data for compensating the second luminance of the second display module from the first target luminance.

In an exemplary embodiment, the first color coordinate data may include a first red x coordinate, a first red y coordinate, a first green x coordinate, a first green y coordinate, a first blue x coordinate, a first blue y coordinate, a first white x coordinate, and a first white y coordinate, and the second color coordinate data may include a second red x coordinate, a second red y coordinate, a second green x coordinate, a second green y coordinate, a second blue x coordinate, a second blue y coordinate, a second white x coordinate, and a second white y coordinate.

In an exemplary embodiment, the luminance divider may be configured to divide the first luminance of the first display module into a first red luminance, a first green luminance, and a first blue luminance from the first color coordinate data and the first white luminance data, and to divide the second luminance of the second display module into a second red luminance, a second green luminance, and a second blue luminance from the second color coordinate data and the second white luminance data.

In an exemplary embodiment, the luminance divider may be configured to: calculate the first red luminance according to RL1=WL1*(Ry1(Gx1Wy1−Bx1Wy1−Gy1Wx1+By1Wx1+Bx1Gy1−By1Gx1)/Wy1 (Gx1Ry1−Bx1Ry1−Gy1Rx1+By1Rx1+Bx1Gy1−By1Gx1)); calculate the first green luminance according to GL1=WL1*(Gy1(Rx1Wy1−Bx1Wy1−Ry1Wx1+By1Wx1+Bx1Ry1−By1Rx1)/Wy1(Gx1Ry1−Bx1Ry1−Gy1Rx1+By1 Rx1+Bx1Gy1−By1Gx1)); and calculate the first blue luminance according to BL1=WL1*(By1 (Rx1Wy1−Gx1Wy1−Ry1Wx1+Gy1Wx1+Gx1Ry1−Gy1Rx1)/Wy1(Gx1Ry1−Bx1 Ry1−Gy1Rx1+By1Rx1+Bx1 Gy1−By1Gx1)), where RL1 denotes the first red luminance, Rx1 denotes the first red x coordinate, Ry1 denotes the first red y coordinate, GL1 denotes the first green luminance, Gx1 denotes the first green x coordinate, Gy1 denotes the first green y coordinate, BL1 denotes the first blue luminance, Bx1 denotes the first blue x coordinate, By1 denotes the first blue y coordinate, WL1 denotes a first white luminance of the first white luminance data, Wx1 denotes the first white x coordinate, and Wy1 denotes the first white y coordinate.

In an exemplary embodiment, the luminance divider may be configured to: calculate the second red luminance according to RL2=WL2*(Ry2(Gx2Wy2−Bx2Wy2−Gy2Wx2+By2Wx2+Bx2Gy2−By2Gx2)/Wy2(Gx2Ry2−Bx2Ry2−Gy2Rx2+By2Rx2+Bx2Gy2−By2Gx2)); calculate the second green luminance according to GL2=WL2*(Gy2(Rx2Wy2−Bx2Wy2−Ry2Wx2+By2Wx2+Bx2Ry2−By2Rx2)/Wy2(Gx2Ry2−Bx2Ry2−Gy2Rx2+By2Rx2+Bx2Gy2−By2Gx2)); and calculate the second blue luminance according to BL2=WL2*(By2(Rx2Wy2−Gx2Wy2−Ry2Wx2+Gy2Wx2+Gx2Ry2−Gy2Rx2)/Wy2(Gx2Ry2−Bx2Ry2−Gy2Rx2+By2Rx2+Bx2Gy2−By2Gx2)), where RL2 denotes the second red luminance, Rx2 denotes the second red x coordinate, Ry2 denotes the second red y coordinate, GL2 denotes the second green luminance, Gx2 denotes the second green x coordinate, Gy2 denotes the second green y coordinate, BL2 denotes the second blue luminance, Bx2 denotes the second blue x coordinate, By2 denotes the second blue y coordinate, WL2 denotes a second white luminance of the second white luminance data, Wx2 denotes the second white x coordinate, and Wy2 denotes the second white y coordinate.

In an exemplary embodiment, the luminance rate calculator may be configured to divide the second red luminance by the first red luminance to output a first red luminance rate, to divide the second green luminance by the first green luminance to output a first green luminance rate, and to divide the second blue luminance by the first blue luminance to output a first blue luminance rate.

In an exemplary embodiment, the target luminance calculator may be configured to divide the second red luminance by the first red luminance rate to output a first target red luminance, to divide the second green luminance by the first green luminance rate to output a first target green luminance, and to divide the second blue luminance by the first blue luminance rate to output a first target blue luminance.

In an exemplary embodiment, the luminance rate calculator may be configured to output the first luminance rate in an interpolation method utilizing first white luminances of the first white luminance data for a plurality of gray values, and first white coordinates of the first color coordinate data.

In an exemplary embodiment, the color coordinate data receiver may be further configured to receive third color coordinate data of a third display module, the luminance data receiver may be further configured to receive third white luminance data of the third display module, the luminance divider may be further configured to divide a third luminance of the third display module from the third color coordinate data and the third white luminance data, the luminance rate calculator may be further configured to calculate a rate of the third luminance compared to the first luminance to further output a second luminance rate, the target luminance calculator may be further configured to divide the third luminance by the second luminance rate to further output a second target luminance of the third display module, and the luminance compensator may be further configured to output second luminance compensating data for compensating the third luminance of the third display module from the second target luminance.

In an exemplary embodiment, the first color coordinate data may include a first red x coordinate, a first red y coordinate, a first green x coordinate, a first green y coordinate, a first blue x coordinate, a first blue y coordinate, a first white x coordinate, and a first white y coordinate, the second color coordinate data may include a second red x coordinate, a second red y coordinate, a second green x coordinate, a second green y coordinate, a second blue x coordinate, a second blue y coordinate, a second white x coordinate, and a second white y coordinate, and the third color coordinate data may include a third red x coordinate, a third red y coordinate, a third green x coordinate, a third green y coordinate, a third blue x coordinate, a third blue y coordinate, a third white x coordinate, and a third white y coordinate.

In an exemplary embodiment, the luminance divider may be configured to divide the first luminance of the first display module into a first red luminance, a first green luminance, and a first blue luminance from the first color coordinate data and the first white luminance data, to divide the second luminance of the second display module into a second red luminance, a second green luminance, and a second blue luminance from the second color coordinate data and the second white luminance data, and to divide the third luminance of the third display module into a third red luminance, a third green luminance, and a third blue luminance from the third color coordinate data and the third white luminance data.

In an exemplary embodiment, the luminance divider may be configured to: calculate the first red luminance according to RL1=WL1*(Ry1(Gx1Wy1−Bx1Wy1−Gy1Wx1+By1Wx1+Bx1Gy1−By1Gx1)/Wy1(Gx1Ry1−Bx1Ry1−Gy1Rx1+By1Rx1+Bx1Gy1−By1Gx1)); calculate the first green luminance according to GL1=WL1*(Gy1(Rx1Wy1−Bx1Wy1−Ry1Wx1+By1Wx1+Bx1Ry1−By1Rx1)/Wy1(Gx1Ry1−Bx1Ry1−Gy1Rx1+By1Rx1+Bx1Gy1−By1Gx1)); and calculate the first blue luminance according to BL1=WL1*(By1(Rx1Wy1−Gx1Wy1−Ry1Wx1+Gy1Wx1+Gx1Ry1−Gy1Rx1)/Wy1(Gx1Ry1−Bx1Ry1−Gy1Rx1+By1Rx1+Bx1Gy1−By1Gx1)), where RL1 denotes the first red luminance, Rx1 denotes the first red x coordinate, Ry1 denotes the first red y coordinate, GL1 denotes the first green luminance, Gx1 denotes the first green x coordinate, Gy1 denotes the first green y coordinate, BL1 denotes the first blue luminance, Bx1 denotes the first blue x coordinate, By1 denotes the first blue y coordinate, WL1 denotes a first white luminance of the first white luminance data, Wx1 denotes the first white x coordinate, and Wy1 denotes the first white y coordinate.

In an exemplary embodiment, the luminance divider may be configured to: calculate the second red luminance according to RL2=WL2*(Ry2(Gx2Wy2−Bx2Wy2−Gy2Wx2+By2Wx2+Bx2Gy2−By2Gx2)/Wy2(Gx2Ry2−Bx2Ry2−Gy2Rx2+By2Rx2+Bx2Gy2−By2Gx2)); calculate the second green luminance according to GL2=WL2*(Gy2(Rx2Wy2−Bx2Wy2−Ry2Wx2+By2Wx2+Bx2Ry2−By2Rx2)/Wy2(Gx2Ry2−Bx2Ry2−Gy2Rx2+By2Rx2+Bx2Gy2−By2Gx2)); and calculate the second blue luminance according to BL2=WL2*(By2(Rx2Wy2−Gx2Wy2−Ry2Wx2+Gy2Wx2+Gx2Ry2−Gy2Rx2)/Wy2(Gx2Ry2−Bx2Ry2−Gy2Rx2+By2Rx2+Bx2Gy2−By2Gx2)), where RL2 denotes the second red luminance, Rx2 denotes the second red x coordinate, Ry2 denotes the second red y coordinate, GL2 denotes the second green luminance, Gx2 denotes the second green x coordinate, Gy2 denotes the second green y coordinate, BL2 denotes the second blue luminance, Bx2 denotes the second blue x coordinate, By2 denotes the second blue y coordinate, WL2 denotes a second white luminance of the second white luminance data, Wx2 denotes the second white x coordinate, and Wy2 denotes the second white y coordinate.

In an exemplary embodiment, the luminance divider may be configured to: calculate the third red luminance according to RL3=WL3*(Ry3(Gx3Wy3−Bx3Wy3−Gy3Wx3+By3Wx3+Bx3Gy3−By3Gx3)/Wy3(Gx3Ry3−Bx3Ry3−Gy3Rx3+By3Rx3+Bx3Gy3−By3Gx3)); calculate the third green luminance according to GL3=WL3*(Gy3(Rx3Wy3−Bx3Wy3−Ry3Wx3+By3Wx3+Bx3Ry3−By3Rx3)/Wy3(Gx3Ry3−Bx3Ry3−Gy3Rx3+By3Rx3+Bx3Gy3−By3Gx3)); and calculate the third blue luminance according to BL3=WL3*(By3(Rx3Wy3−Gx3Wy3−Ry3Wx3+Gy3Wx3+Gx3Ry3−Gy3Rx3)/Wy3(Gx3Ry3−Bx3Ry3−Gy3Rx3+By3Rx3+Bx3Gy3−By3Gx3)), where RL3 denotes the third red luminance, Rx3 denotes the third red x coordinate, Ry3 denotes the third red y coordinate, GL3 denotes the third green luminance, Gx3 denotes the third green x coordinate, Gy3 denotes the third green y coordinate, BL3 denotes the third blue luminance, Bx3 denotes the third blue x coordinate, By3 denotes the third blue y coordinate, WL3 denotes a third white luminance of the third white luminance data, Wx3 denotes the third white x coordinate, and Wy3 denotes the third white y coordinate.

In an exemplary embodiment, the luminance rate calculator may be configured to divide the second red luminance by the first red luminance to output a first red luminance rate, to divide the second green luminance by the first green luminance to output a first green luminance rate, to divide the second blue luminance by the first blue luminance to output a first blue luminance rate, to divide the third red luminance by the first red luminance to output a second red luminance rate, to divide the third green luminance by the first green luminance to output a second green luminance rate, and to divide the third blue luminance by the first blue luminance to output a second blue luminance rate.

In an exemplary embodiment, the target luminance calculator may be configured to divide the second red luminance by the first red luminance rate to output a first target red luminance, to divide the second green luminance by the first green luminance rate to output a first target green luminance, to divide the second blue luminance by the first blue luminance rate to output a first target blue luminance, to divide the third red luminance by the second red luminance rate to output a second target red luminance, to divide the third green luminance by the second green luminance rate to output a second target green luminance, and to divide the third blue luminance by the second blue luminance rate to output a second target blue luminance.

According to an exemplary embodiment of the present inventive concept, a method of compensating a luminance includes: receiving first color coordinate data of a first display module; receiving second color coordinate data of a second display module; receiving first white luminance data of the first display module; receiving second white luminance data of the second display module; dividing a first luminance of the first display module from the first color coordinate data and the first white luminance data; dividing a second luminance of the second display module from the second color coordinate data and the second white luminance data; calculating a rate of the second luminance compared to the first luminance to output a first luminance rate; dividing the second luminance by the first luminance rate to output a first target luminance of the second display module; and outputting first luminance compensating data for compensating the second luminance of the second display module from the first target luminance.

In an exemplary embodiment, the method may further include: receiving third color coordinate data of a third display module; receiving third white luminance data of the third display module; dividing a third luminance of the third display module from the third color coordinate data and the third white luminance data; calculating a rate of the third luminance compared to the first luminance to output a second luminance rate; dividing the third luminance by the second luminance rate to output a second target luminance of the third display module; and outputting second luminance compensating data for compensating the third luminance of the third display module from the second target luminance.

According to an exemplary embodiment of the present inventive concept, a display system includes: a display apparatus including a first display module and a second display module; and a luminance compensator including: a color coordinate data receiver configured to receive first color coordinate data of the first display module and second color coordinate data of the second display module; a white luminance data receiver configured to receive first white luminance data of the first display module and second white luminance data of the second display module; a luminance divider configured to divide a first luminance of the first display module from the first color coordinate data and the first white luminance data, and to divide a second luminance of the second display module from the second color coordinate data and the second white luminance data; a luminance rate calculator configured to calculate a rate of the second luminance compared to the first luminance to output a first luminance rate; a target luminance calculator configured to divide the second luminance by the first luminance rate to output a first target luminance of the second display module; and a luminance compensator configured to output first luminance compensating data for compensating the second luminance of the second display module from the first target luminance.

In an exemplary embodiment, the display apparatus may further include a third display module, the color coordinate data receiver may be further configured to receive third color coordinate data of a third display module, the luminance data receiver may be further configured to receive third white luminance data of the third display module, the luminance divider may be further configured to divide a third luminance of the third display module from the third color coordinate data and the third white luminance data, the luminance rate calculator may be further configured to calculate a rate of the third luminance compared to the first luminance to further output a second luminance rate, the target luminance calculator may be further configured to divide the third luminance by the second luminance rate to further output a second target luminance of the third display module, and the luminance compensator may be further configured to output second luminance compensating data for compensating the third luminance of the third display module from the second target luminance.

According to one or more aspects of exemplary embodiments of the present inventive concept, the luminance compensating apparatus may compensate a luminance of a second (e.g., a slave) display module, such that a luminance of a first (e.g., a master) display module in a display apparatus and the luminance of the second display module in the display apparatus are the same or substantially the same. Thus, display quality of the display apparatus may be improved.

### BRIEF DESCRIPTION OF THE DRAWINGS

The above and other aspects and features of the present inventive concept will become more apparent to those skilled in the art from the following detailed description of the example embodiments with reference to the accompanying drawings, in which:

FIG. 1 is a block diagram illustrating a display system according to an exemplary embodiment of the present inventive concept;

FIG. 2 is a block diagram illustrating a luminance compensating apparatus of FIG. 1;

FIG. 3 is a graph illustrating a red luminance rate of FIG. 2;

FIG. 4 is a graph illustrating luminance rates before and after a second luminance of a second display module of FIG. 1 is compensated by the luminance compensating apparatus of FIGS. 1 and 2;

FIG. 5 is graph illustrating a difference between a first white x coordinate of a first display module and a second white x coordinate of the second display module before and after the second luminance of the second display module of FIG. 1 is compensated by the luminance compensating apparatus of FIGS. 1 and 2;

FIG. 6 is graph illustrating a difference between a first white y coordinate of the first display module and a second white y coordinate of the second display module before and after the second luminance of the second display module of FIG. 1 is compensated by the luminance compensating apparatus of FIGS. 1 and 2;

FIG. 7 is a flow chart illustrating a method of compensating a luminance using the luminance compensating apparatus of FIGS. 1 and 2;

FIG. 8 is a block diagram illustrating a display system according to an exemplary embodiment of the present inventive concept;

FIG. 9 is a block diagram illustrating a luminance compensating apparatus of FIG. 8;

FIG. 10 is a graph illustrating a first red luminance rate and a second red luminance rate of FIG. 9;

FIG. 11 is a graph illustrating red luminance rates before and after a second luminance of a second display module and a third luminance of a third display module are compensated by the luminance compensating apparatus of FIGS. 8 and 9; and

FIGS. 12A-12B are flowcharts illustrating a method of compensating a luminance using the luminance compensating apparatus of FIGS. 8 and 9.

### DETAILED DESCRIPTION

Hereinafter, example embodiments will be described in more detail with reference to the accompanying drawings. The present inventive concept, however, may be embodied in various different forms, and should not be construed as being limited to only the illustrated embodiments herein. Rather, these embodiments are provided as examples so that this disclosure will be thorough and complete, and will fully convey the aspects and features of the inventive concept to those skilled in the art. Accordingly, processes, elements, and techniques that are not necessary to those having ordinary skill in the art for a complete understanding of the aspects and features of the inventive concept may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the inventive concept.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the inventive concept refers to “one or more embodiments of the inventive concept.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

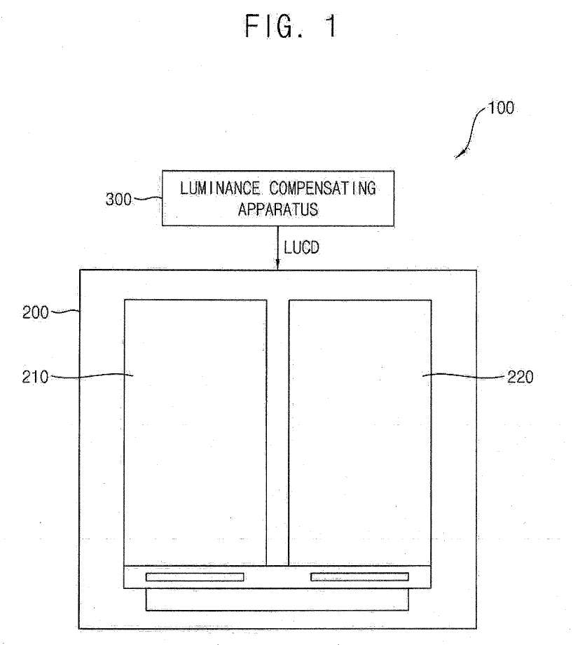

FIG. 1 is a block diagram illustrating a display system according to an exemplary embodiment of the present inventive concept.

Referring to FIG. 1, the display system 100 according to the present exemplary embodiment includes a display apparatus 200 and a luminance compensating apparatus (e.g., a luminance compensator) 300.

The display apparatus 200 includes a first display module 210 and a second display module 220. The first display module 210 may be referred to as a master display module, and the second display module 220 may be referred to as a slave display module. The first display module 210 and the second display module 220 are connected to each other. Each of the first display module 210 and the second display module 220 includes a display panel and a display panel driving apparatus, which drives the display panel. For example, the display apparatus 100 may be a Head Mounted Display (HMD). In addition, for example, the display panel may be an Organic Light Emitting Diode (OLED) display panel including an OLED. Alternatively, the display panel may be a liquid crystal display panel including a liquid crystal. However, the inventive concept is not limited thereto, and the display panel may be any suitable display panel.

The first display module 210 may have a first luminance and the second display module 220 may have a second luminance.

The luminance compensating apparatus 300 outputs luminance compensating data LUCD for compensating the second luminance of the second display module 220, such that the first luminance of the first display module 210 and the second luminance of the second display module 220 are the same or substantially the same.

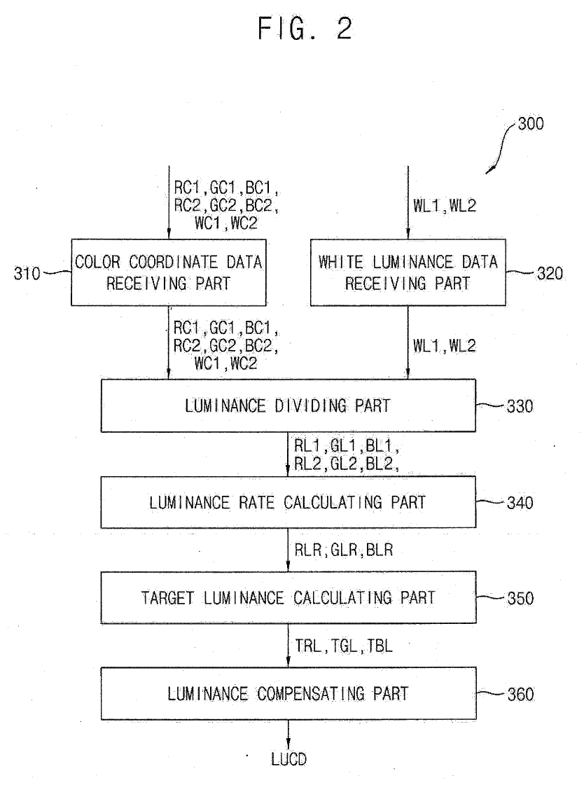

FIG. 2 is a block diagram illustrating the luminance compensating apparatus 300 of FIG. 1.

Referring to FIGS. 1 and 2, the luminance compensating apparatus 300 includes a color coordinate data receiving part (e.g., a color coordinate data receiver) 310, a white luminance data receiving part (e.g., a white luminance data receiver) 320, a luminance dividing part (e.g., a luminance divider) 330, a luminance rate calculating part (e.g., a luminance rate calculator) 340, a target luminance calculating part (e.g., a target luminance calculator) 350, and a luminance compensating part (e.g., a luminance compensator) 360.

The color coordinate data receiving part 310 receives first color coordinate data RC1, GC1, BC1, and WC1 of the first display module 210 from the outside, and outputs the first color coordinate data RC1, GC1, BC1, and WC1 to the luminance dividing part 330. The first color coordinate data RC1, GC1, BC1, and WC1 may include a first red coordinate RC1, a first green coordinate GC1, a first blue coordinate BC1, and a first white coordinate WC1. The first red coordinate RC1 may include a first red x coordinate and a first red y coordinate. The first green coordinate GC1 may include a first green x coordinate and a first green y coordinate. The first blue coordinate BC1 may include a first blue x coordinate and a first blue y coordinate. The first white coordinate WC1 may include a first white x coordinate and a first white y coordinate.

The color coordinate data receiving part 310 receives second color coordinate data RC2, GC2, BC2, and WC2 of the second display module 220 from the outside, and outputs the second color coordinate data RC2, GC2, BC2, and WC2 to the luminance dividing part 330. The second color coordinate data RC2, GC2, BC2, and WC2 may include a second red coordinate RC2, a second green coordinate GC2, a second blue coordinate BC2, and a second white coordinate WC2. The second red coordinate RC2 may include a second red x coordinate and a second red y coordinate. The second green coordinate GC2 may include a second green x coordinate and a second green y coordinate. The second blue coordinate BC2 may include a second blue x coordinate and a second blue y coordinate. The second white coordinate WC2 may include a second white x coordinate and a second white y coordinate.

The white luminance data receiving part 320 receives first white luminance data WL1 of the first display module 210 and second white luminance data WL2 of the second display module 220, and outputs the first white luminance data WL1 and the second white luminance data WL2 to the luminance dividing part 330. The first white luminance data WL1 may be referred to as a first white luminance, and the second white luminance data WL2 may be referred to as a second white luminance.

The first white luminance data WL1 and the first white coordinate WC1 of the first display module 210 may include the first white luminances, the first white x coordinates, and the first white y coordinates for a plurality of grayscales (e.g., gray values or grayscale values). For example, grayscale values of the grayscales may include 11, 51, and 255. In addition, for example, the first white luminances, the first white x coordinates, and the first white y coordinates for the grayscales may be the same or substantially the same as shown in the following Table 1.

TABLE 1

| | First display module 210 | | |
|---|---|---|---|
| Division | First white | First white x | First white y |
| Grayscale value | luminance (nit) | coordinate | coordinate |
| 255 | 356.1 | 0.2958 | 0.3192 |
| 51 | 10.56 | 0.2974 | 0.3228 |
| 11 | 0.37 | 0.2571 | 0.2879 |

The second white luminance data WL2 and the second white coordinate WC2 of the second display module 220 may include the second white luminances, the second white x coordinates, and the second white y coordinates for the grayscales (e.g., gray values or grayscale values). For example, the second white luminances, the second white x coordinates, and the second white y coordinates for the grayscales may be the same or substantially the same as shown in the following Table 2.

TABLE 2

| | Second display module 220 | | |
|---|---|---|---|
| Division | Second white | Second white x | Second white y |
| Grayscale value | luminance (nit) | coordinate | coordinate |
| 255 | 353.3 | 0.2956 | 0.3200 |
| 51 | 10.8 | 0.2970 | 0.3247 |
| 11 | 0.41 | 0.2584 | 0.2954 |

The luminance dividing part 330 receives the first color coordinate data RC1, GC1, BC1, and WC1 of the first display module 210 and the second color coordinate data RC2, GC2, BC2, and WC2 of the second display module 220 from the color coordinate data receiving part 310. In addition, the luminance dividing part 330 receives the first white luminance data WL1 of the first display module 210 and the second white luminance data WL2 of the second display module 220 from the white luminance data receiving part 320.

The luminance dividing part 330 divides the first luminance of the first display module 210 from the first color coordinate data RC1, GC1, BC1, and WC1 and the first white luminance data WL1. For example, the luminance dividing part 330 divides the first luminance of the first display module 210 into a first red luminance RL1, a first green luminance GU, and a first blue luminance BL1. The luminance dividing part 330 may calculate the first red luminance RL1 according to Equation 1, may calculate the first green luminance GL1 according to Equation 2, and may calculate the first blue luminance BL1 according to Equation 3.

RL1=WL1*(Ry1(Gx1Wy1−Bx1Wy1−Gy1Wx1+By1Wx1+Bx1Gy1−By1Gx1)/Wy1(Gx1Ry1−Bx1Ry1−Gy1Rx1+By1Rx1+Bx1Gy1−By1Gx1)) Equation 1:

GL1=WL1*(Gy1(Rx1Wy1−Bx1Wy1−Ry1Wx1+By1Wx1+Bx1Ry1−By1Rx1)/Wy1(Gx1Ry1−Bx1Ry1−Gy1Rx1+By1Rx1+Bx1Gy1−By1Gx1)) Equation 2:

BL1=WL1*(By1(Rx1Wy1−Gx1Wy1−Ry1Wx1+Gy1Wx1+Gx1Ry1−Gy1Rx1)/Wy1(Gx1Ry1−Bx1Ry1−Gy1Rx1+By1Rx1+Bx1Gy1−By1Gx1)) Equation 3:

In Equation 1, Equation 2, and Equation 3, RL1 denotes the first red luminance RL1, Rx1 denotes the first red x coordinate, Ry1 denotes the first red y coordinate, GL1 denotes the first green luminance GL1, Gx1 denotes the first green x coordinate, Gy1 denotes the first green y coordinate, BL1 denotes the first blue luminance BL1, Bx1 denotes the first blue x coordinate, By1 denotes the first blue y coordinate, WL1 denotes the first white luminance WL1, Wx1 denotes the first white x coordinate, and Wy1 denotes the first white y coordinate.

The luminance dividing part 330 may calculate the first red luminances RL1, the first green luminances GL1, and the first blue luminances BL1 for the grayscales (e.g., the gray values). For example, the first red luminances RL1, the first green luminances GL1, and the first blue luminances BL1 for the grayscales may be the same or substantially the same as shown in the following Table 3.

TABLE 3

| | First display module 210 | | |
|---|---|---|---|
| Division | First red | First green | First blue |
| Grayscale value | luminance RL1 | luminance GL1 | luminance BL1 |
| 255 | 87.82202 | 242.3751 | 23.14591 |
| 51 | 2.554026 | 7.482333 | 0.772642 |
| 11 | 0.07415 | 0.302793 | 0.040057 |

In addition, the luminance dividing part 330 divides the second luminance of the second display module 220 from the second color coordinate data RC2, GC2, BC2, and WC2 and the second white luminance data WL2. For example, the luminance dividing part 330 divides the second luminance of the second display module 220 into a second red luminance RL2, a second green luminance GL2, and a second blue luminance BL2. The luminance dividing part 330 may calculate the second red luminance RL2 according to Equation 4, may calculate the second green luminance GL2 according to Equation 5, and may calculate the second blue luminance BL2 according to Equation 6.

RL2=WL2*(Ry2(Gx2Wy2−Bx2Wy2−Gy2Wx2+By2Wx2+Bx2Gy2−By2Gx2)/Wy2(Gx2Ry2−Bx2Ry2−Gy2Rx2+By2Rx2+Bx2Gy2−By2Gx2)) Equation 4:

GL2=WL2*(Gy2(Rx2Wy2−Bx2Wy2−Ry2Wx2+By2Wx2+Bx2Ry2−By2Rx2)/Wy2(Gx2Ry2−Bx2Ry2−Gy2Rx2+By2Rx2+Bx2Gy2−By2Gx2)) Equation 5:

BL2=WL2*(By2(Rx2Wy2−Gx2Wy2−Ry2Wx2+Gy2Wx2+Gx2Ry2−Gy2Rx2)/Wy2(Gx2Ry2−Bx2Ry2−Gy2Rx2+By2Rx2+Bx2Gy2−By2Gx2)) Equation 6:

In Equation 4, Equation 5, and Equation 6, RL2 denotes the second red luminance RL2, Rx2 denotes the second red x coordinate, Ry2 denotes the second red y coordinate, GL2 denotes the second green luminance GL2, Gx2 denotes the second green x coordinate, Gy2 denotes the second green y coordinate, BL2 denotes the second blue luminance BL2, Bx2 denotes the second blue x coordinate, By2 denotes the second blue y coordinate, WL2 denotes the second white luminance WL2, Wx2 denotes the second white x coordinate, and Wy2 denotes the second white y coordinate.

The luminance dividing part 330 may calculate the second red luminances RL2, the second green luminances GL2, and the second blue luminances BL2 for the grayscales (e.g., the gray values or grayscale values). For example, the second red luminances RL2, the second green luminances GL2, and the second blue luminances BL2 for the grayscales may be the same or substantially the same as shown in the following Table 4.

TABLE 4

| | Second display module 220 | | |
|---|---|---|---|
| Division | Second red | Second green | Second blue |
| Grayscale value | luminance RL2 | luminance GL2 | luminance BL2 |
| 255 | 88.79642 | 244.0344 | 23.36716 |
| 51 | 2.52132 | 7.253768 | 0.760912 |
| 11 | 0.068456 | 0.267878 | 0.037666 |

The luminance dividing part 330 outputs the first red luminance RL1, the first green luminance GL1, the first blue luminance BL1, the second red luminance RL2, the second green luminance GL2, and the second blue luminance BL2 to the luminance rate calculating part 340.

The luminance rate calculating part 340 calculates a rate of the second luminance of the second display module 220 compared to the first luminance of the first display module 210, and outputs a luminance rate. For example, the luminance rate calculating part 340 receives the first red luminance RL1, the first green luminance GL1, the first blue luminance BL1, the second red luminance RL2, the second green luminance GL2, and the second blue luminance BL2. The luminance rate calculating part 340 divides the second red luminance RL2 by the first red luminance RL1, and outputs a red luminance rate RLR. The luminance rate calculating part 340 divides the second green luminance GL2 by the first green luminance GL1, and outputs a green luminance rate GLR. The luminance rate calculating part 340 divides the second blue luminance BL2 by the first blue luminance BL1, and outputs a blue luminance rate BLR.

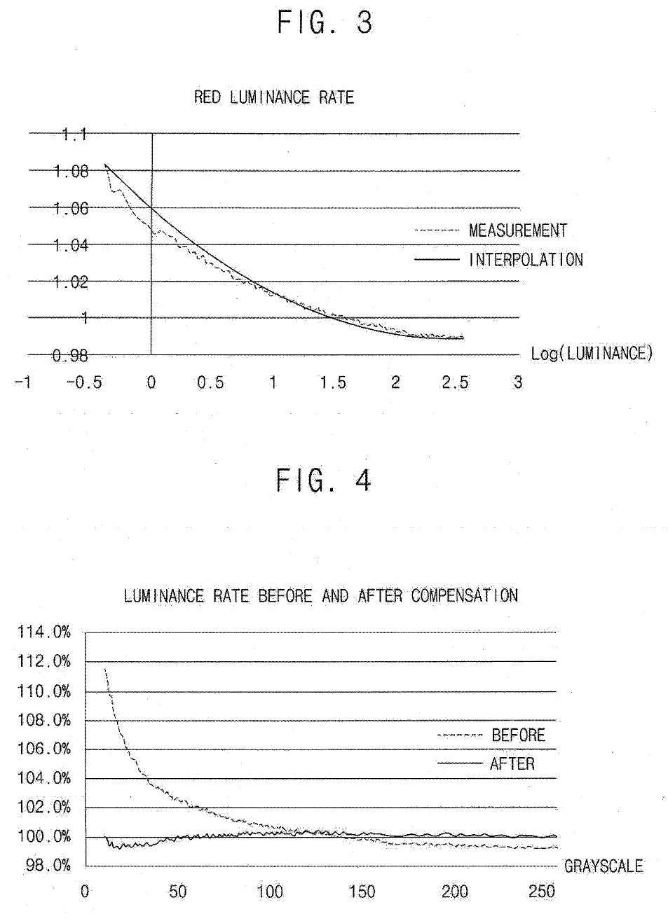

FIG. 3 is a graph illustrating the red luminance rate RLR of FIG. 2.

Referring to FIGS. 2 and 3, the luminance rate calculating part 340 may output the red luminance rates RLR that are calculated based on the first white luminances WL1, the first white x coordinates, and the first white y coordinates for the grayscales (e.g., the gray values) in an interpolation method. In the same or substantially the same manner, the luminance rate calculating part 340 may output the green luminance rates GLR that are calculated based on the first white luminances WL1, the first white x coordinates, and the first white y coordinates for the grayscales (e.g., gray values) in the interpolation method, and may output the blue luminance rates BLR that are calculated based on the first white luminances WL1, the first white x coordinates, and the first white y coordinates for the grayscales (e.g., gray values) in the interpolation method.

The interpolation method may use a quadratic interpolation or a Lagrange interpolation.

When three data points (x1, y1), (x2, y2), and (x3, y3) are given (where x1<x2<x3), the quadratic interpolation may be used by the following Equation 7, Equation 8, Equation 9, and Equation 10.

$$\begin{matrix}{F}_{2} ( x ) = {b}_{0} + {b}_{1} ( x - {x}_{1} ) + {b}_{2} ( x - {x}_{1} ) ( x - {x}_{2} ) & Equation 7 \\ {b}_{0} = {y}_{1} & Equation 8 \\ {b}_{1} = \frac{{y}_{2} - {y}_{1}}{{x}_{2} - {x}_{1}} & Equation 9 \\ {b}_{2} = \frac{\frac{{y}_{3} - {y}_{2}}{{x}_{3} - {x}_{2}} - \frac{{y}_{2} - {y}_{1}}{{x}_{2} - {x}_{1}}}{{x}_{3} - {x}_{1}} & Equation 10\end{matrix}$$

The Lagrange interpolation is an n-th linear interpolation, and the Lagrange interpolation may be used by the following Equation 11 and Equation 12.

$$\begin{matrix}{F}_{n} ( x ) = {\sum }_{i = 1}^{n + 1} {L}_{i} ( x ) {y}_{i} & Equation 11 \\ {L}_{i} ( x ) = \frac{\begin{matrix}( x - {x}_{1} ) ( x - {x}_{2} ) … \\ ( x - {x}_{i - 1} ) ( x - {x}_{i + 1} ) … ( x - {x}_{n + 1} )\end{matrix}}{\begin{matrix}( {x}_{i} - {x}_{1} ) ( {x}_{i} - {x}_{2} ) … \\ ( {x}_{i} - {x}_{i - 1} ) ( {x}_{i} - {x}_{i + 1} ) … ( {x}_{i} - {x}_{n + 1} )\end{matrix}} = {\prod }_{{j = 1}_{j \neq i}}^{n + 1} [ \frac{x - {x}_{j}}{{x}_{i} - {x}_{j}} ] & Equation 12\end{matrix}$$

Referring to FIGS. 1 and 2, the target luminance calculating part 350 divides the second luminance of the second display module 220 by the luminance rate to calculate a target luminance of the second display module 220. For example, the target luminance calculating part 350 divides the second red luminance RL2 by the red luminance rate RLR to calculate a target red luminance TRL. The target luminance calculating part 350 divides the second green luminance GL2 by the green luminance rate GLR to calculate a target green luminance TGL. The target luminance calculating part 350 divides the second blue luminance BL2 by the blue luminance rate BLR to calculate a target blue luminance TBL. The target luminance calculating part 350 outputs the target red luminance TRL, the target green luminance TGL, and the target blue luminance TBL to the luminance compensating part 360.

The luminance compensating part 360 receives the target luminance of the second display module 220 from the target luminance calculating part 350, and outputs the luminance compensating data LUCD for compensating the second luminance of the second display module 220 from the target luminance of the second display module 220. For example, the luminance compensating part 360 receives the target red luminance TRL, the target green luminance TGL, and the target blue luminance TBL from the target luminance calculating part 350. The luminance compensating part 360 searches for gamma register values according to each of the target red luminance TRL, the target green luminance TGL, and the target blue luminance TBL, and outputs gamma values, color coordinate data, and white luminance data corresponding to the gamma register values as the luminance compensating data LUCD. For example, the target red luminance TRL and the gamma register values according to the target red luminance TRL may be the same or substantially the same as shown in the following Table 5.

TABLE 5

| | Target red luminance |
|---|---|
| Gamma register value | TRL |
| 303 | 88.8 |
| 302 | 88.3 |
| 301 | 87.8 |

For example, when the second luminance of the second display module 220 before the second luminance is compensated by the luminance compensating apparatus 300 is about 87.8 and the target red luminance TRL is about 88.8, the gamma register value may be changed from 301 to 303.

In another exemplary embodiment, the first white luminance WL1 and the first white coordinate WC1 may be calculated from the first red luminance RL1, the first green luminance GL1, and the first blue luminance BL1 based on Equation 1, Equation 2, and Equation 3. First tristimulus value XYZ data may be calculated from the first white luminance WL1 and the first white coordinate WC1, and first RGB data may be calculated from the first tristimulus value XYZ data. The second white luminance WL2 and the second white coordinate WC2 may be calculated from the second red luminance RL2, the second green luminance GL2, and the second blue luminance BL2 based on Equation 4, Equation 5, and Equation 6. Second tristimulus value XYZ data may be calculated from the second white luminance WL2 and the second white coordinate WC2, and second RGB data may be calculated from the second tristimulus value XYZ data. The luminance compensating data LUCD, which compensates the second luminance such that the second RGB data is the same or substantially the same as the second RGB data, may be output.

FIG. 4 is a graph illustrating luminance rates before and after the second luminance of the second display module 220 of FIG. 1 is compensated by the luminance compensating apparatus 300 of FIGS. 1 and 2.

Referring to FIGS. 1, 2, and 4, in all grayscales (e.g., gray values), a luminance rate between the first display module 210 and the second display module 220 after the second luminance of the second display module 220 is compensated by the luminance compensating apparatus 300 is closer to about 100% when compared to the luminance rate between the first display module 210 and the second display module 220 before the second luminance of the second display module 220 is compensated by the luminance compensating apparatus 300.

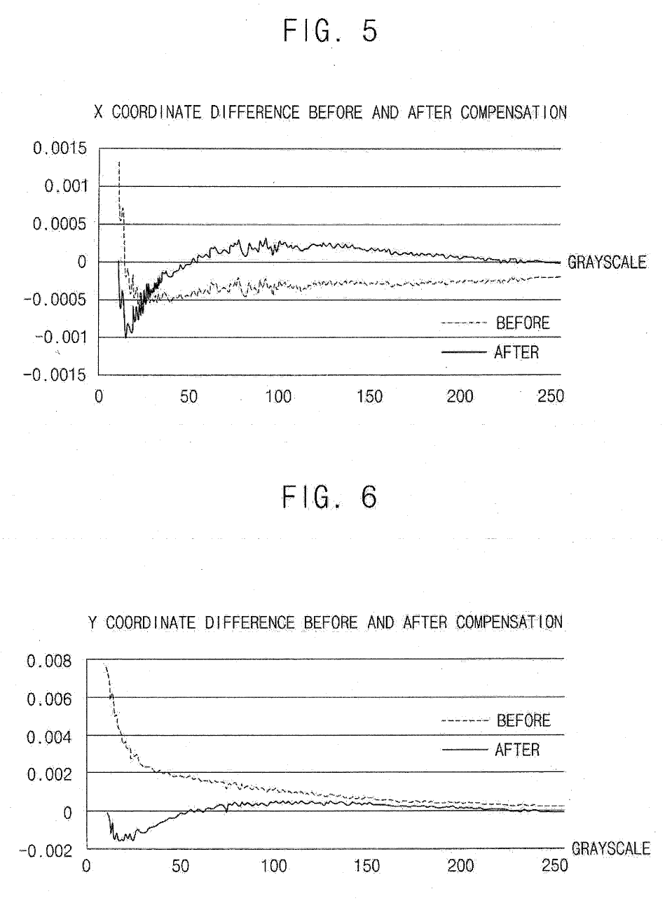

FIG. 5 is graph illustrating a difference between the first white x coordinate of the first display module 210 and the second white x coordinate of the second display module 220 before and after the second luminance of the second display module 220 of FIG. 1 is compensated by the luminance compensating apparatus 300 of FIGS. 1 and 2.

Referring to FIGS. 1, 2, and 5, in most of the grayscales (e.g., the gray values or grayscale values), a difference between the first white x coordinate of the first display module 210 and the second white x coordinate of the second display module 220 after the second luminance of the second display module 220 is compensated by the luminance compensating apparatus 300 is closer to about 0 compared to the difference between the first white x coordinate of the first display module 210 and the second white x coordinate of the second display module 220 before the second luminance of the second display module 220 is compensated by the luminance compensating apparatus 300.

FIG. 6 is graph illustrating a difference between the first white y coordinate of the first display module 210 and the second white y coordinate of the second display module 220 before and after the second luminance of the second display module 220 of FIG. 1 is compensated by the luminance compensating apparatus 300 of FIGS. 1 and 2.

Referring to FIGS. 1, 2, and 6, in all the grayscales (e.g., the gray values or grayscale values), a difference between the first white y coordinate of the first display module 210 and the second white y coordinate of the second display module 220 after the second luminance of the second display module 220 is compensated by the luminance compensating apparatus 300 is closer to about 0 compared to the difference between the first white y coordinate of the first display module 210 and the second white y coordinate of the second display module 220 before the second luminance of the second display module 220 is compensated by the luminance compensating apparatus 300.

Thus, the first luminance of the first display module 210 and the second luminance of the second display module 220 may be the same or substantially the same by the luminance compensating apparatus 300.

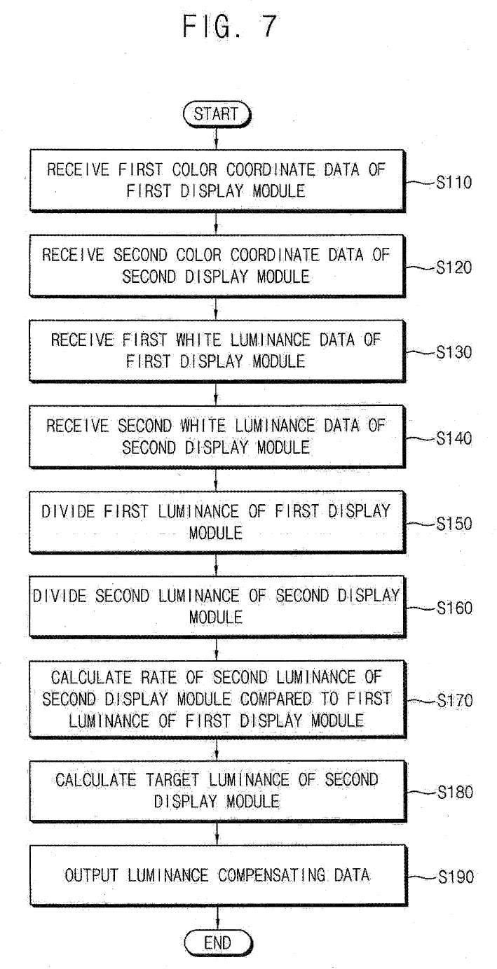

FIG. 7 is a flow chart illustrating a method of compensating a luminance using the luminance compensating apparatus 300 of FIGS. 1 and 2.

Referring to FIGS. 1, 2, and 7, the first color coordinate data RC1, GC1, BC1, and WC1 of the first display module 210 are received (block S110). For example, the color coordinate data receiving part 310 receives the first color coordinate data RC1, GC1, BC1, and WC1 of the first display module 210 from the outside, and outputs the first color coordinate data RC1, GC1, BC1, and WC1 to the luminance dividing part 330. The first color coordinate data RC1, GC1, BC1, and WC1 may include the first red coordinate RC1, the first green coordinate GC1, the first blue coordinate BC1, and the first white coordinate WC1. The first red coordinate RC1 may include the first red x coordinate and the first red y coordinate. The first green coordinate GC1 may include the first green x coordinate and the first green y coordinate. The first blue coordinate BC1 may include the first blue x coordinate and the first blue y coordinate. The first white coordinate WC1 may include the first white x coordinate and the first white y coordinate.

The second color coordinate data RC2, GC2, BC2, and WC2 of the second display module 220 are received (block S120). For example, the color coordinate data receiving part 310 receives the second color coordinate data RC2, GC2, BC2, and WC2 of the second display module 220 from the outside, and outputs the second color coordinate data RC2, GC2, BC2, and WC2 to the luminance dividing part 330. The second color coordinate data RC2, GC2, BC2, and WC2 may include the second red coordinate RC2, the second green coordinate GC2, the second blue coordinate BC2, and the second white coordinate WC2. The second red coordinate RC2 may include the second red x coordinate and the second red y coordinate. The second green coordinate GC2 may include the second green x coordinate and the second green y coordinate. The second blue coordinate BC2 may include the second blue x coordinate and the second blue y coordinate. The second white coordinate WC2 may include the second white x coordinate and the second white y coordinate.

The first white luminance data WL1 of the first display module 210 is received (block S130). For example, the white luminance data receiving part 320 receives the first white luminance data WL1 of the first display module 210 from the outside, and outputs the first white luminance data WL1 to the luminance dividing part 330. The first white luminance data WL1 may be referred to as the first white luminance,

The second white luminance data WL2 of the second display module 220 is received (block S140). For example, the white luminance data receiving part 320 receives the second white luminance data WL2 of the second display module 210 from the outside, and outputs the second white luminance data WL2 to the luminance dividing part 330. The second white luminance data WL2 may be referred to as the second white luminance.

The first luminance of the first display module 210 is divided (block S150). For example, the luminance dividing part 330 receives the first color coordinate data RC1, GC1, BC1, and WC1 of the first display module 210 from the color coordinate data receiving part 310, and receives the first white luminance data WL1 of the first display module 210 from the white luminance data receiving part 320. The luminance dividing part 330 divides the first luminance into the first red luminance RL1, the first green luminance GL1, and the first blue luminance BL1 from the first color coordinate data RC1, GC1, BC1, and WC1 and the first white luminance data WL1 of the first display module 210. The luminance dividing part 330 may calculate the first red luminance RL1 according to Equation 1, may calculate the first green luminance GL1 according to Equation 2, and may calculate the first blue luminance BL1 according to Equation 3.

The second luminance of the second display module 220 is divided (block S160). For example, the luminance dividing part 330 receives the second color coordinate data RC2, GC2, BC2, and WC2 of the second display module 220 from the color coordinate data receiving part 310, and receives the second white luminance data WL2 of the second display module 220 from the white luminance data receiving part 320. The luminance dividing part 330 divides the second luminance into the second red luminance RL2, the second green luminance GL2, and the second blue luminance BL2 from the second color coordinate data RC2, GC2, BC2, and WC2 and the second white luminance data WL2 of the second display module 220. The luminance dividing part 330 may calculate the second red luminance RL2 by Equation 4, may calculate the second green luminance GL2 by Equation 5, and may calculate the second blue luminance BL2 by Equation 6.

The rate of the second luminance of the second display module compared to the first luminance of the first display module 210 is calculated (block S170). For example, the luminance rate calculating part 340 calculates the rate of the second luminance of the second display module 220 compared to the first luminance of the first display module 210, and outputs the luminance rate. The luminance rate calculating part 340 receives the first red luminance RL1, the first green luminance GL1, the first blue luminance BL1, the second red luminance RL2, the second green luminance GL2, and the second blue luminance BL2. The luminance rate calculating part 340 divides the second red luminance RL2 by the first red luminance RL1, and outputs the red luminance rate RLR. The luminance rate calculating part 340 divides the second green luminance GL2 by the first green luminance GL1, and outputs the green luminance rate GLR. In addition, the luminance rate calculating part 340 divides the second blue luminance BL2 by the first blue luminance BL1, and outputs the blue luminance rate BLR.

The target luminance of the second display module 220 is calculated (block S180). For example, the target luminance calculating part 350 divides the second luminance of the second display module 220 by the luminance rate to calculate the target luminance of the second display module 220. The target luminance calculating part 350 divides the second red luminance RL2 by the red luminance rate RLR to calculate the target red luminance TRL. The target luminance calculating part 350 divides the second green luminance GL2 by the green luminance rate GLR to calculate the target green luminance TGL. In addition, the target luminance calculating part 350 divides the second blue luminance BL2 by the blue luminance rate BLR to calculate the target blue luminance TBL. The target luminance calculating part 350 outputs the target red luminance TRL, the target green luminance TGL, and the target blue luminance TBL to the luminance compensating part 360.

The luminance compensating data LUCD is output (block S190). For example, the luminance compensating part 360 receives the target luminance of the second display module 220 from the target luminance calculating part 350, and outputs the luminance compensating data LUCD for compensating the second luminance of the second display module 220 from the target luminance of the second display module 220. The luminance compensating part 360 receives the target red luminance TRL, the target green luminance TGL, and the target blue luminance TBL from the target luminance calculating part 350. The luminance compensating part 360 searches for the gamma register values according to each of the target red luminance TRL, the target green luminance TGL, and the target blue luminance TBL, and outputs the gamma values, the color coordinate data, and the white luminance data corresponding to the gamma register values as the luminance compensating data LUCD.

In one or more exemplary embodiments, the display apparatus 200 includes the first display module 210 and the second display module 220, but the inventive concept is not limited thereto. For example, the display apparatus 200 may include only the first display module 210. In this case, the luminance compensating apparatus 300 may compensate a luminance of a second position, such that the luminance of the second position is the same or substantially the same as a luminance of a first position, based on color coordinate data and white luminance data of the second position of the first display module 210.

According to one or more exemplary embodiments, the luminance compensating apparatus 300 outputs the luminance compensating data LUCD for compensating the second luminance of the second display module 220, such that the first luminance of the first display module 210 and the second luminance of the second display module 220 are the same or substantially the same. Thus, display quality of the display apparatus 200 may be improved.

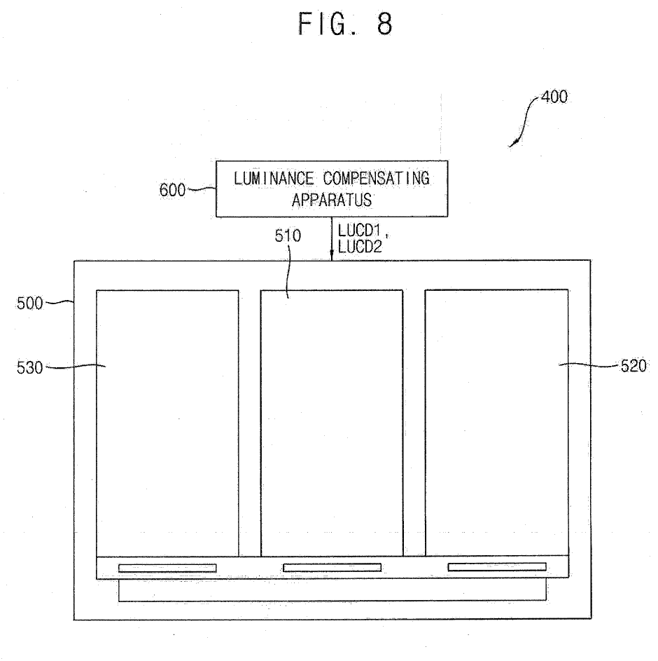

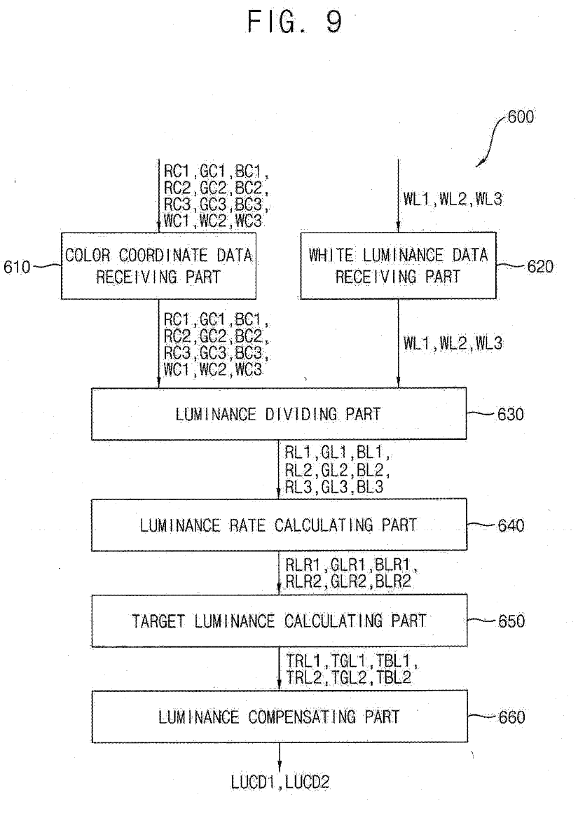

FIG. 8 is a block diagram illustrating a display system according to an exemplary embodiment of the present inventive concept.

Referring to FIG. 8, the display system 400 includes a display apparatus 500 and a luminance compensating apparatus (e.g., a luminance compensator) 600.

The display apparatus 500 includes a first display module 510, a second display module 520, and a third display module 530. The first display module 510 may be referred to as a master display module, and each of the second display module 520 and the third display module 530 may be referred to as a slave display module. The first display module 510, the second display module 520, and the third display module 530 are connected to each other. The first display module 510 may be disposed between the second display module 520 and the third display module 530.

Each of the first display module 510, the second display module 520, and the third display module 530 includes a display panel and a display panel driving apparatus (e.g., a display panel driver) to drive the display panel. For example, the display panel may be an Organic Light Emitting Diode (OLED) display panel including an OLED. Alternatively, the display panel may be a liquid crystal display panel including a liquid crystal. However, the inventive concept is not limited thereto, and the display panel may be any suitable display panel.

The first display module 510 may have a first luminance, the second display module 520 may have a second luminance, and the third display module 530 may have a third luminance.

The luminance compensating apparatus 600 outputs first luminance compensating data LUCD1 for compensating the second luminance of the second display module 520, and second luminance compensating data LUCD2 for compensating the third luminance of the third display module 530, such that the first luminance of the first display module 510, the second luminance of the second display module 520, and the third luminance of the third display module 530 are the same or substantially the same.

FIG. 9 is a block diagram illustrating the luminance compensating apparatus 600 of FIG. 8.

Referring to FIGS. 8 and 9, the luminance compensating apparatus 600 includes a color coordinate data receiving part (e.g., a color coordinate data receiver) 610, a white luminance data receiving part (e.g., a white luminance data receiver) 620, a luminance dividing part (e.g., a luminance divider) 630, a luminance rate calculating part (e.g., a luminance rate calculator) 640, a target luminance calculating part (e.g., a target luminance calculator) 650, and a luminance compensating part (e.g., a luminance compensator) 660.

The color coordinate data receiving part 610 receives first color coordinate data RC1, GC1, BC1, and WC1 of the first display module 510 from an outside, and outputs the first color coordinate data RC1, GC1, BC1, and WC1 to the luminance dividing part 630. The first color coordinate data RC1, GC1, BC1, and WC1 may include a first red coordinate RC1, a first green coordinate GC1, a first blue coordinate BC1, and a first white coordinate WC1. The first red coordinate RC1 may include a first red x coordinate and a first red y coordinate. The first green coordinate GC1 may include a first green x coordinate and a first green y coordinate. The first blue coordinate BC1 may include a first blue x coordinate and a first blue y coordinate. The first white coordinate WC1 may include a first white x coordinate and a first white y coordinate.

The color coordinate data receiving part 610 receives second color coordinate data RC2, GC2, BC2, and WC2 of the second display module 520 from the outside, and outputs the second color coordinate data RC2, GC2, BC2, and WC2 to the luminance dividing part 630. The second color coordinate data RC2, GC2, BC2, and WC2 may include a second red coordinate RC2, a second green coordinate GC2, a second blue coordinate BC2, and a second white coordinate WC2. The second red coordinate RC2 may include a second red x coordinate and a second red y coordinate. The second green coordinate GC2 may include a second green x coordinate and a second green y coordinate. The second blue coordinate BC2 may include a second blue x coordinate and a second blue y coordinate. The second white coordinate WC2 may include a second white x coordinate and a second white y coordinate.

The color coordinate data receiving part 610 receives third color coordinate data RC3, GC3, BC3, and WC3 of the third display module 530 from the outside, and outputs the third color coordinate data RC3, GC3, BC3, and WC3 to the luminance dividing part 630. The third color coordinate data RC3, GC3, BC3, and WC3 may include a third red coordinate RC3, a third green coordinate GC3, a third blue coordinate BC3, and a third white coordinate WC3. The third red coordinate RC3 may include a third red x coordinate and a third red y coordinate. The third green coordinate GC3 may include a third green x coordinate and a third green y coordinate. The third blue coordinate BC3 may include a third blue x coordinate and a third blue y coordinate. The third white coordinate WC3 may include a third white x coordinate and a third white y coordinate.

The white luminance data receiving part 620 receives first white luminance data WL1 of the first display module 510, second white luminance data WL2 of the second display module 520, and third white luminance data WL3 of the third display module 530, and outputs the first white luminance data WL1, the second white luminance data WL2, and the third white luminance data WL3 to the luminance dividing part 630. The first white luminance data WL1 may be referred to as a first white luminance, the second white luminance data WL2 may be referred to as a second white luminance, and the third white luminance data WL3 may be referred to as a third white luminance.

The first white luminance data WL1 and the first white coordinate WC1 of the first display module 510 may include the first white luminances, the first white x coordinates, and the first white y coordinates for a plurality of grayscales (e.g., gray values or grayscale values). For example, grayscale values of the grayscales may include, for example, 11, 51, and 255. In addition, for example, the first white luminances, the first white x coordinates, and the first white y coordinates for the grayscales (e.g., the gray values or grayscale values) may be the same or substantially the same as those shown in Table 1 above.

The second white luminance data WL2 and the second white coordinate WC2 of the second display module 520 may include the second white luminances, the second white x coordinates, and the second white y coordinates for the grayscales (e.g., the gray values or grayscale values). For example, the second white luminances, the second white x coordinates, and the second white y coordinates for the grayscales (e.g., the gray values or grayscale values) may be the same or substantially the same as those shown in Table 2 above.

The third white luminance data WL3 and the third white coordinate WC3 of the third display module 530 may include the third white luminances, the third white x coordinates, and the third white y coordinates for the grayscales (e.g., the gray values or grayscale values). For example, the third white luminances, the third white x coordinates, and the third white y coordinates for the grayscales (e.g., the gray values or grayscale values) may be the same or substantially the same as those shown in the following Table 6.

TABLE 6

| | Third display module 230 | | |
|---|---|---|---|
| Division | Third white | Third white x | Third white y |
| Grayscale value | luminance (nit) | coordinate | coordinate |
| 255 | 352.8 | 0.2961 | 0.3170 |
| 51 | 9.00 | 0.2965 | 0.3149 |
| 11 | 0.22 | 0.2490 | 0.2545 |

The luminance dividing part 630 receives the first color coordinate data RC1, GC1, BC1, and WC1 of the first display module 510, the second color coordinate data RC2, GC2, BC2, and WC2 of the second display module 520, and the third color coordinate data RC3, GC3, BC3, and WC3 of the third display module 530 from the color coordinate data receiving part 610. In addition, the luminance dividing part 630 receives the first white luminance data WL1 of the first display module 510, the second white luminance data WL2 of the second display module 520, and the third white luminance data WL3 of the third display module 530 from the white luminance data receiving part 620.

The luminance dividing part 630 divides the first luminance of the first display module 510 from the first color coordinate data RC1, GC1, BC1, and WC1 and the first white luminance data WL1. For example, the luminance dividing part 630 divides the first luminance of the first display module 510 into a first red luminance RL1, a first green luminance GL1, and a first blue luminance BL1. The luminance dividing part 630 may calculate the first red luminance RL1 according to Equation 1 above, may calculate the first green luminance GL1 according to Equation 2 above, and may calculate the first blue luminance BL1 according to Equation 3 above.

The luminance dividing part 630 may calculate the first red luminances RL1, the first green luminances GL1, and the first blue luminances BL1 for the grayscales (e.g., the gray values or grayscale values). For example, the first red luminances RL1, the first green luminances GL1, and the first blue luminances BL1 for the grayscales (e.g., the gray values or grayscale values) may be the same or substantially the same as those shown in Table 3 above.

In addition, the luminance dividing part 630 divides the second luminance of the second display module 520 from the second color coordinate data RC2, GC2, BC2, and WC2 and the second white luminance data WL2. For example, the luminance dividing part 630 divides the second luminance of the second display module 520 into a second red luminance RL2, a second green luminance GL2, and a second blue luminance BL2. The luminance dividing part 630 may calculate the second red luminance RL2 according to Equation 4 above, may calculate the second green luminance GL2 according to Equation 5 above, and may calculate the second blue luminance BL2 according to Equation 6 above.

The luminance dividing part 630 may calculate the second red luminances RL2, the second green luminances GL2, and the second blue luminances BL2 for the grayscales (e.g., the gray values or grayscale values). For example, the second red luminances RL2, the second green luminances GL2, and the second blue luminances BL2 for the grayscales (e.g., the gray values or grayscale values) may be the same or substantially the same as those shown in Table 4 above.

In addition, the luminance dividing part 630 divides the third luminance of the third display module 530 from the third color coordinate data RC3, GC3, BC3, and WC3 and the third white luminance data WL3. For example, the luminance dividing part 630 divides the third luminance of the third display module 530 into a third red luminance RL3, a third green luminance GL3, and a third blue luminance BL3. The luminance dividing part 630 may calculate the third red luminance RL3 according to Equation 13, may calculate the third green luminance GL3 according to Equation 14, and may calculate the third blue luminance BL3 according to Equation 15.

RL3=WL3*(Ry3(Gx3Wy3−Bx3Wy3−Gy3Wx3+By3Wx3+Bx3Gy3−By3Gx3)/Wy3(Gx3Ry3−Bx3Ry3−Gy3Rx3+By3Rx3+Bx3Gy3−By3Gx3)) Equation 13:

GL3=WL3*(Gy3(Rx3Wy3−Bx3Wy3−Ry3Wx3+By3Wx3+Bx3Ry3−By3Rx3)/Wy3(Gx3Ry3−Bx3Ry3−Gy3Rx3+By3Rx3+Bx3Gy3−By3Gx3)) Equation 14:

BL3=WL3*(By3(Rx3Wy3−Gx3Wy3−Ry3Wx3+Gy3Wx3+Gx3Ry3−Gy3Rx3)/Wy3(Gx3Ry3−Bx3Ry3−Gy3Rx3+By3Rx3+Bx3Gy3−By3Gx3)) Equation 15:

In Equation 13, Equation 14, and Equation 15, RL3 denotes the third red luminance RL3, Rx3 denotes the third red x coordinate, Ry3 denotes the third red y coordinate, GL3 denotes the third green luminance GL3, Gx3 denotes the third green x coordinate, Gy3 denotes the third green y coordinate, BL3 denotes the third blue luminance BL3, Bx3 denotes the third blue x coordinate, By3 denotes the third blue y coordinate, WL3 denotes the third white luminance WL3, Wx3 denotes the third white x coordinate, and Wy3 denotes the third white y coordinate.

The luminance dividing part 630 may calculate the third red luminances RL3, the third green luminances GL3, and the third blue luminances BL3 for the grayscales (e.g., the gray values). For example, the third red luminances RL3, the third green luminances GL3, and the third blue luminances BL3 for the grayscales (e.g., the gray values) may be the same or substantially the same as those shown in the following Table 7.

TABLE 7

| | Third display module 530 | | |
|---|---|---|---|
| Division | Third red | Third green | Third blue |
| Grayscale value | luminance RL3 | luminance GL3 | luminance BL3 |
| 255 | 89.21974 | 240.1663 | 23.50992 |
| 51 | 2.219284 | 6.104701 | 0.684014 |
| 11 | 0.045928 | 0.151769 | 0.028303 |

The luminance dividing part 630 outputs the first red luminance RL1, the first green luminance GL1, the first blue luminance BL1, the second red luminance RL2, the second green luminance GL2, the second blue luminance BL2, the third red luminance RL3, the third green luminance GL3, and the third blue luminance BL3 to the luminance rate calculating part 640.

The luminance rate calculating part 640 calculates a rate of the second luminance of the second display module 520 compared to the first luminance of the first display module 510, and outputs a first luminance rate. For example, the luminance rate calculating part 640 receives the first red luminance RL1, the first green luminance GL1, the first blue luminance BL1, the second red luminance RL2, the second green luminance GL2, and the second blue luminance BL2 from the luminance dividing part 630. The luminance rate calculating part 640 divides the second red luminance RL2 by the first red luminance RL1, and outputs a first red luminance rate RLR1. The luminance rate calculating part 640 divides the second green luminance GL2 by the first green luminance GL1, and outputs a first green luminance rate GLR1. In addition, the luminance rate calculating part 640 divides the second blue luminance BL2 by the first blue luminance BL1, and outputs a first blue luminance rate BLR1.

In addition, the luminance rate calculating part 640 calculates a rate of the third luminance of the third display module 530 compared to the first luminance of the first display module 510, and outputs a second luminance rate. For example, the luminance rate calculating part 640 receives the first red luminance RL1, the first green luminance GL1, the first blue luminance BL1, the third red luminance RL3, the third green luminance GL3, and the third blue luminance BL3 from the luminance dividing part 630. The luminance rate calculating part 640 divides the third red luminance RL3 by the first red luminance RL1, and outputs a second red luminance rate RLR2. The luminance rate calculating part 640 divides the third green luminance GL3 by the first green luminance GL1, and outputs a second green luminance rate GLR2. In addition, the luminance rate calculating part 640 divides the third blue luminance BL3 by the first blue luminance BL1, and outputs a second blue luminance rate BLR2.

The luminance rate calculating part 640 may output each of the first red luminance rates RLR1, the first green luminance rates GLR2, the first blue luminance rates BLR1, the second red luminance rates RLR2, the second green luminance rates GLR2, and the second blue luminance rates BLR2 calculated based on the first white luminances WL1, the first white x coordinates, and the first white y coordinates for the grayscales (e.g., the gray values) in an interpolation method.

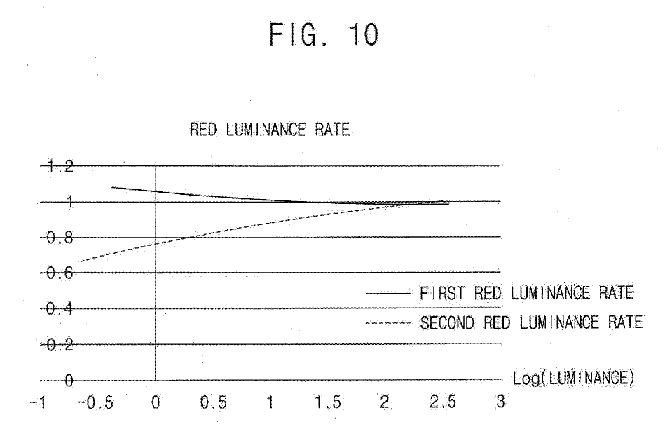

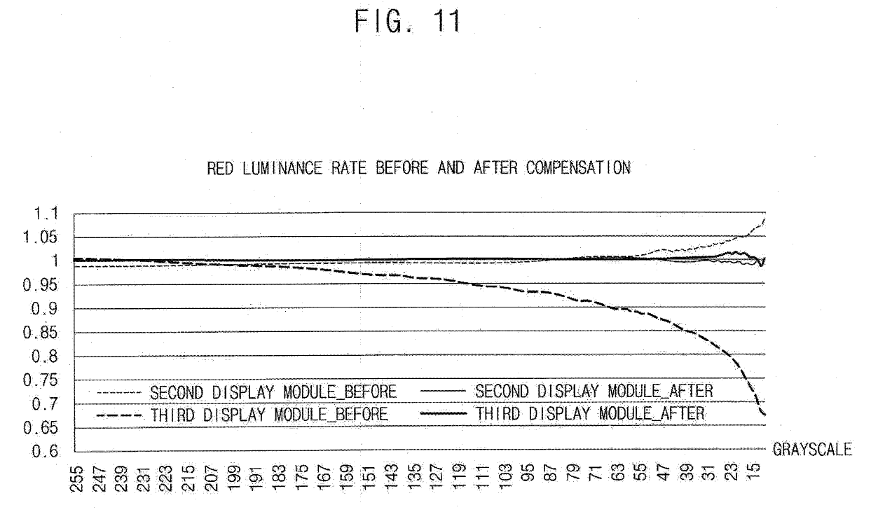

FIG. 10 is a graph illustrating the first red luminance rate RLR1 and the second red luminance rate RLR2 of FIG. 9.

Referring to FIGS. 9 and 10, a red luminance rate may be calculated according to Equation 16.

Y=a2X2+a1X+a0 Equation 16:

In Equation 16, Y denotes the red luminance rate, X denotes a log value of a luminance, a value of a2 may be about 0.011559, a value of a1 may be about −0.05722, and a value of a0 may be about 1.059767.

Each of the first red luminance rate RLR1 and the second red luminance rate RLR2 may be output in an interpolation method for the grayscales (e.g., the gray values). For example, values of the grayscales may be, for example, 11, 51, and 255, and the log values of the luminance for the grayscales (e.g., the gray values) and the first red luminance rate RLR1 of the second display module 520 may be the same or substantially the same as those shown in the following Table 8.

TABLE 8

| | Log value | First red luminance |
|---|---|---|
| Grayscale value | of luminance | rate RLR1 |
| 255 | 2.548196 | 0.989027 |
| 51 | 1.033786 | 1.012972 |
| 11 | −0.37986 | 1.083169 |

Referring to FIGS. 8 and 9 again, the target luminance calculating part 650 divides the second luminance of the second display module 520 by the first luminance rate to calculate a first target luminance of the second display module 520. For example, the target luminance calculating part 650 divides the second red luminance RL2 by the first red luminance rate RLR1 to calculate a first target red luminance TRL1. The target luminance calculating part 650 divides the second green luminance GL2 by the first green luminance rate GLR1 to calculate a first target green luminance TGL1. In addition, the target luminance calculating part 650 divides the second blue luminance BL2 by the first blue luminance rate BLR1 to calculate a first target blue luminance TBL1. The target luminance calculating part 650 outputs the first target red luminance TRL1, the first target green luminance TGL1, and the first target blue luminance TBL1 to the luminance compensating part 660.

In addition, the target luminance calculating part 650 divides the third luminance of the third display module 530 by the second luminance rate to calculate a second target luminance of the third display module 530. For example, the target luminance calculating part 650 divides the third red luminance RL3 by the second red luminance rate RLR2 to calculate a second target red luminance TRL2. The target luminance calculating part 650 divides the third green luminance GL3 by the second green luminance rate GLR2 to calculate a second target green luminance TGL2. In addition, the target luminance calculating part 650 divides the third blue luminance BL3 by the second blue luminance rate BLR2 to calculate a second target blue luminance TBL2. The target luminance calculating part 650 outputs the second target red luminance TRL2, the second target green luminance TGL2, and the second target blue luminance TBL2 to the luminance compensating part 660.

The luminance compensating part 660 receives the first target luminance of the second display module 520 from the target luminance calculating part 650, and outputs the first luminance compensating data LUCD1 for compensating the second luminance of the second display module 520 from the first target luminance of the second display module 520. For example, the luminance compensating part 660 receives the first target red luminance TRL1, the first target green luminance TGL1, and the first target blue luminance TBL1 from the target luminance calculating part 650. The luminance compensating part 660 searches for gamma register values according to each of the first target red luminance TRL1, the first target green luminance TGL1, and the first target blue luminance TBL1, and outputs gamma values, color coordinate data, and white luminance data corresponding to the gamma register values as the first luminance compensating data LUCD1.

In addition, the luminance compensating part 660 receives the second target luminance of the third display module 530 from the target luminance calculating part 650, and outputs the second luminance compensating data LUCD2 for compensating the third luminance of the third display module 530 from the second target luminance of the third display module 530. For example, the luminance compensating part 660 receives the second target red luminance TRL2, the second target green luminance TGL2, and the second target blue luminance TBL2 from the target luminance calculating part 650. The luminance compensating part 660 searches for gamma register values according to each of the second target red luminance TRL2, the second target green luminance TGL2, and the second target blue luminance TBL2, and outputs gamma values, color coordinate data, and white luminance data corresponding to the gamma register values as the second luminance compensating data LUCD2.

FIG. 11 is a graph illustrating red luminance rates before and after the second luminance of the second display module 520 and the third luminance of the third display module 530 are compensated by the luminance compensating apparatus 600 of FIGS. 8 and 9.

Referring to FIGS. 8, 9, and 11, on average, the first red luminance rate RLR1 between the first display module 510 and the second display module 520 after the second luminance of the second display module 520 is compensated by the luminance compensating apparatus 600 is closer to about 1 when compared to the first red luminance rate RLR1 between the first display module 510 and the second display module 520 before the second luminance of the second display module 520 is compensated by the luminance compensating apparatus 600. In addition, on average, the second red luminance rate RLR2 between the first display module 510 and the third display module 530 after the third luminance of the third display module 530 is compensated by the luminance compensating apparatus 600 is closer to about 1 when compared to the second red luminance rate RLR2 between the first display module 510 and the third display module 530 before the third luminance of the third display module 530 is compensated by the luminance compensating apparatus 600.

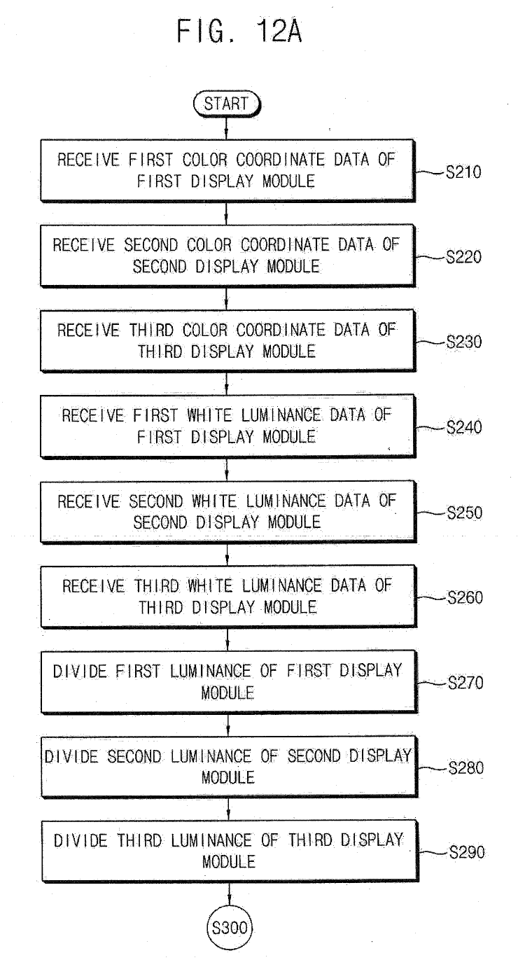

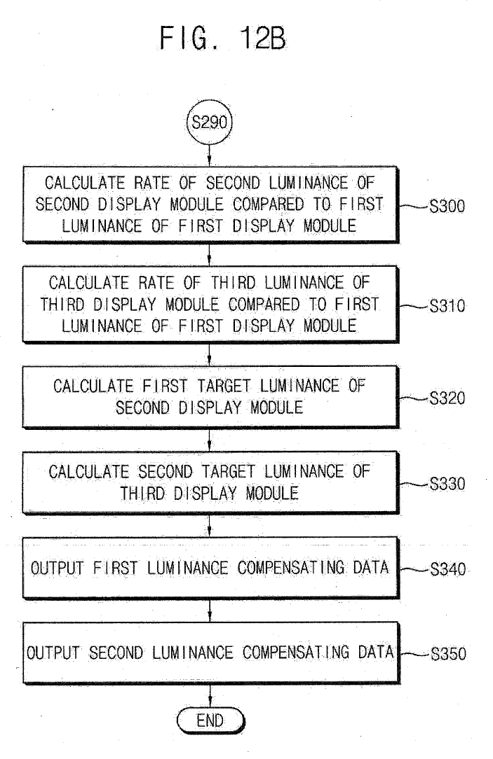

FIGS. 12A and 12B are flowcharts illustrating a method of compensating a luminance using the luminance compensating apparatus 600 of FIGS. 8 and 9.

Referring to FIGS. 8, 9, 12A, and 12B, the first color coordinate data RC1, GC1, BC1, and WC1 of the first display module 510 are received (block S210). For example, the color coordinate data receiving part 610 receives the first color coordinate data RC1, GC1, BC1, and WC1 of the first display module 510 from the outside, and outputs the first color coordinate data RC1, GC1, BC1, and WC1 to the luminance dividing part 630. The first color coordinate data RC1, GC1, BC1, and WC1 may include the first red coordinate RC1, the first green coordinate GC1, the first blue coordinate BC1, and the first white coordinate WC1. The first red coordinate RC1 may include the first red x coordinate and the first red y coordinate. The first green coordinate GC1 may include the first green x coordinate and the first green y coordinate. The first blue coordinate BC1 may include the first blue x coordinate and the first blue y coordinate. The first white coordinate WC1 may include the first white x coordinate and the first white y coordinate.

The second color coordinate data RC2, GC2, BC2, and WC2 of the second display module 520 are received (block S220). For example, the color coordinate data receiving part 610 receives the second color coordinate data RC2, GC2, BC2, and WC2 of the second display module 520 from the outside, and outputs the second color coordinate data RC2, GC2, BC2, and WC2 to the luminance dividing part 630. The second color coordinate data RC2, GC2, BC2, and WC2 may include the second red coordinate RC2, the second green coordinate GC2, the second blue coordinate BC2, and the second white coordinate WC2. The second red coordinate RC2 may include the second red x coordinate and the second red y coordinate. The second green coordinate GC2 may include the second green x coordinate and the second green y coordinate. The second blue coordinate BC2 may include the second blue x coordinate and the second blue y coordinate. The second white coordinate WC2 may include the second white x coordinate and the second white y coordinate.

The third color coordinate data RC3, GC3, BC3, and WC3 of the third display module 530 are received (block S230). For example, the color coordinate data receiving part 610 receives the third color coordinate data RC3, GC3, BC3, and WC3 of the third display module 530 from the outside, and outputs the third color coordinate data RC3, GC3, BC3, and WC3 to the luminance dividing part 630. The third color coordinate data RC3, GC3, BC3, and WC3 may include the third red coordinate RC3, the third green coordinate GC3, the third blue coordinate BC3, and the third white coordinate WC3. The third red coordinate RC3 may include the third red x coordinate and the third red y coordinate. The third green coordinate GC3 may include the third green x coordinate and the third green y coordinate. The third blue coordinate BC3 may include the third blue x coordinate and the third blue y coordinate. The third white coordinate WC3 may include the third white x coordinate and the third white y coordinate.

The first white luminance data WL1 of the first display module 510 is received (block S240). For example, the white luminance data receiving part 620 receives the first white luminance data WL1 of the first display module 510 from the outside, and outputs the first white luminance data WL1 to the luminance dividing part 630.

The second white luminance data WL2 of the second display module 520 is received (block S250). For example, the white luminance data receiving part 620 receives the second white luminance data WL2 of the second display module 520 from the outside, and outputs the second white luminance data WL2 to the luminance dividing part 630.

The third white luminance data WL3 of the third display module 530 is received (block S260). For example, the white luminance data receiving part 620 receives the third white luminance data WL3 of the third display module 530 from the outside, and outputs the third white luminance data WL3 to the luminance dividing part 630.

The first luminance of the first display module 510 is divided (block S270). For example, the luminance dividing part 630 receives the first color coordinate data RC1, GC1, BC1, and WC1 of the first display module 510 from the color coordinate data receiving part 610, and receives the first white luminance data WL1 of the first display module 510 from the white luminance data receiving part 620. The luminance dividing part 630 divides the first luminance of the first display module 510 into the first red luminance RL1, the first green luminance GL1, and the first blue luminance BL1 from the first color coordinate data RC1, GC1, BC1, and WC1 and the first white luminance data WL1. The luminance dividing part 630 may calculate the first red luminance RL1 according to Equation 1 above, may calculate the first green luminance GL1 according to Equation 2 above, and may calculate the first blue luminance BL1 according to Equation 3 above.

The second luminance of the second display module 520 is divided (block S280). For example, the luminance dividing part 630 receives the second color coordinate data RC2, GC2, BC2, and WC2 of the second display module 520 from the color coordinate data receiving part 610, and receives the second white luminance data WL2 of the second display module 520 from the white luminance data receiving part 620. The luminance dividing part 630 divides the second luminance of the second display module 520 into the second red luminance RL2, the second green luminance GL2, and the second blue luminance BL2 from the second color coordinate data RC2, GC2, BC2, and WC2 and the second white luminance data WL2. The luminance dividing part 630 may calculate the second red luminance RL2 according to Equation 4 above, may calculate the second green luminance GL2 according to Equation 5 above, and may calculate the second blue luminance BL2 according to Equation 6 above.

The third luminance of the third display module 530 is divided (block S290). For example, the luminance dividing part 630 receives the third color coordinate data RC3, GC3, BC3, and WC3 of the third display module 530 from the color coordinate data receiving part 610, and receives the third white luminance data WL3 of the third display module 530 from the white luminance data receiving part 620. The luminance dividing part 630 divides the third luminance of the third display module 530 into the third red luminance RL3, the third green luminance GL3, and the third blue luminance BL3 from the third color coordinate data RC3, GC3, BC3, and WC3 and the third white luminance data WL3. The luminance dividing part 630 may calculate the third red luminance RL3 according to Equation 13 above, may calculate the third green luminance GL3 according to Equation 14 above, and may calculate the third blue luminance BL3 according to Equation 15 above.

The rate of the second luminance of the second display module 520 compared to the first luminance of the first display module 510 is calculated (block S300). For example, the luminance rate calculating part 640 calculates a rate of the second luminance of the second display module 520 compared to the first luminance of the first display module 510, and outputs the first luminance rate. The luminance rate calculating part 640 receives the first red luminance RL1, the first green luminance GL1, the first blue luminance BL1, the second red luminance RL2, the second green luminance GL2, and the second blue luminance BL2 from the luminance dividing part 630. The luminance rate calculating part 640 divides the second red luminance RL2 by the first red luminance RL1, and outputs the first red luminance rate RLR1. The luminance rate calculating part 640 divides the second green luminance GL2 by the first green luminance GL1, and outputs the first green luminance rate GLR1. In addition, the luminance rate calculating part 640 divides the second blue luminance BL2 by the first blue luminance BL1, and outputs the first blue luminance rate BLR1.

The rate of the third luminance of the third display module 530 compared to the first luminance of the first display module 510 is calculated (block S310). For example, the luminance rate calculating part 640 calculates the rate of the third luminance of the third display module 530 compared to the first luminance of the first display module 510, and outputs the second luminance rate. The luminance rate calculating part 640 receives the first red luminance RL1, the first green luminance GL1, the first blue luminance BL1, the third red luminance RL3, the third green luminance GL3, and the third blue luminance BL3 from the luminance dividing part 630. The luminance rate calculating part 640 divides the third red luminance RL3 by the first red luminance RL1, and outputs the second red luminance rate RLR2. The luminance rate calculating part 640 divides the third green luminance GL3 by the first green luminance GL1, and outputs the second green luminance rate GLR2. In addition, the luminance rate calculating part 640 divides the third blue luminance BL3 by the first blue luminance BL1, and outputs the second blue luminance rate GLR2.

The first target luminance of the second display module 520 is calculated (block S320). For example, the target luminance calculating part 650 divides the second luminance of the second display module 520 by the first luminance rate to calculate the first target luminance of the second display module 520. The target luminance calculating part 650 divides the second red luminance RL2 by the first red luminance rate RLR1 to calculate the first target red luminance TRL1. The target luminance calculating part 650 divides the second green luminance GL2 by the first green luminance rate GLR1 to calculate the first target green luminance TGL1. In addition, the target luminance calculating part 650 divides the second blue luminance BL2 by the first blue luminance rate BLR1 to calculate the first target blue luminance TBL1. The target luminance calculating part 650 outputs the first target red luminance TRL1, the first target green luminance TGL1, and the first target blue luminance TBL1 to the luminance compensating part 660.

The second target luminance of the third display module 530 is calculated (block S330). For example, the target luminance calculating part 650 divides the third luminance of the third display module 530 by the second luminance rate to calculate the second target luminance of the third display module 530. The target luminance calculating part 650 divides the third red luminance RL3 by the second red luminance rate RLR2 to calculate the second target red luminance TRL2. The target luminance calculating part 650 divides the third green luminance GL3 by the second green luminance rate GLR2 to calculate the second target green luminance TGL2. In addition, the target luminance calculating part 650 divides the third blue luminance BL3 by the second blue luminance rate BLR2 to calculate the second target blue luminance TBL2. The target luminance calculating part 650 outputs the second target red luminance TRL2, the second target green luminance TGL2, and the second target blue luminance TBL2 to the luminance compensating part 660.

The first luminance compensating data LUCD1 is output (block S340). For example, the luminance compensating part 660 receives the first target luminance of the second display module 520 from the target luminance calculating part 650, and outputs the first luminance compensating data LUCD1 for compensating the second luminance of the second display module 520 from the first target luminance of the second display module 520. The luminance compensating part 660 receives the first target red luminance TRL1, the first target green luminance TGL1, and the first target blue luminance TBL1 from the target luminance calculating part 650. The luminance compensating part 660 searches for the gamma register values according to each of the first target red luminance TRL1, the first target green luminance TGL1, and the first target blue luminance TBL1, and outputs the gamma values, the color coordinate data. and the white luminance data corresponding to the gamma register values as the first luminance compensating data LUCD1.

The second luminance compensating data LUCD2 is output (block S350). For example, the luminance compensating part 660 receives the second target luminance of the third display module 530 from the target luminance calculating part 650, and outputs the second luminance compensating data LUCD2 for compensating the third luminance of the third display module 530 from the second target luminance of the third display module 530. The luminance compensating part 660 receives the second target red luminance TRL2, the second target green luminance TGL2, and the second target blue luminance TBL2 from the target luminance calculating part 650. The luminance compensating part 660 searches for gamma register values according to each of the second target red luminance TRL2, the second target green luminance TGL2, and the second target blue luminance TBL2, and outputs the gamma values, the color coordinate data, and the white luminance data corresponding to the gamma register values as the second luminance compensating data LUCD2.

According to one or more exemplary embodiments, the luminance compensating apparatus 600 outputs the first luminance compensating data LUCD1 for compensating the second luminance of the second display module 520, and outputs the second luminance compensating data LUCD2 for compensating the third luminance of the third display module 530, such that the first luminance of the first display module 510, the second luminance of the second display module 520, and the third luminance of the third display module 530 are the same or substantially the same. Thus, display quality of the display apparatus 500 may be improved.

According to a luminance compensating apparatus, a method of compensating a luminance using the luminance compensating apparatus, and a display system having the luminance compensating apparatus, the luminance compensating apparatus compensates a luminance of a second (e.g., a slave) display module, such that a luminance of a first (e.g., a master) display module in a display apparatus and the luminance of the second display module in the display apparatus are the same or substantially the same. Thus, display quality of the display apparatus may be improved.

The electronic or electric devices (e.g., the luminance compensating apparatus) and/or any other relevant devices or components (e.g., the color coordinate data receiving part, the white luminance data receiving part, the luminance dividing part, the luminance rate calculating part, the target luminance calculating part, the luminance compensating part, etc.) according to embodiments of the inventive concept described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the inventive concept.

The foregoing is illustrative of the present inventive concept and is not to be construed as limiting thereof. Although a few exemplary embodiments of the present inventive concept have been described, those skilled in the art will readily appreciate that various modifications are possible, without departing from the spirit and scope of the present inventive concept. Accordingly, all such modifications are intended to be included within the scope of the present inventive concept as defined in the claims, and their equivalents. In the claims, means-plus-function clauses, if any, are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed herein, and that modifications to the disclosed exemplary embodiments, as well as other exemplary embodiments, are intended to be included within the spirit and scope of the appended claims, and their equivalents. The present inventive concept is defined by the following claims, with equivalents of the claims to be included therein.

What is claimed is:

1. A luminance compensating apparatus comprising:
a color coordinate data receiver configured to receive first color coordinate data of a first display module and second color coordinate data of a second display module;
a white luminance data receiver configured to receive first white luminance data of the first display module and second white luminance data of the second display module;
a luminance divider configured to divide a first luminance of the first display module from the first color coordinate data and the first white luminance data, and to divide a second luminance of the second display module from the second color coordinate data and the second white luminance data;
a luminance rate calculator configured to calculate a rate of the second luminance compared to the first luminance to output a first luminance rate;
a target luminance calculator configured to divide the second luminance by the first luminance rate to output a first target luminance of the second display module; and
a luminance compensator configured to output first luminance compensating data for compensating the second luminance of the second display module from the first target luminance.

2. The luminance compensating apparatus of claim 1, wherein the first color coordinate data comprises a first red x coordinate, a first red y coordinate, a first green x coordinate, a first green y coordinate, a first blue x coordinate, a first blue y coordinate, a first white x coordinate, and a first white y coordinate, and
the second color coordinate data comprises a second red x coordinate, a second red y coordinate, a second green x coordinate, a second green y coordinate, a second blue x coordinate, a second blue y coordinate, a second white x coordinate, and a second white y coordinate.

3. The luminance compensating apparatus of claim 2, wherein the luminance divider is configured to divide the first luminance of the first display module into a first red luminance, a first green luminance, and a first blue luminance from the first color coordinate data and the first white luminance data, and to divide the second luminance of the second display module into a second red luminance, a second green luminance, and a second blue luminance from the second color coordinate data and the second white luminance data.

4. The luminance compensating apparatus of claim 3, wherein the luminance divider is configured to:
calculate the first red luminance according to RL1=WL1*(Ry1(Gx1Wy1−Bx1Wy1−Gy1Wx1+By1Wx1+Bx1Gy1−By1Gx1)/Wy1(Gx1 Ry1−Bx1Ry1−Gy1Rx1+By1Rx1+Bx1Gy1−By1Gx1));
calculate the first green luminance according to GL1=WL1*(Gy1(Rx1Wy1−Bx1Wy1−Ry1Wx1+By1Wx1+Bx1Ry1−By1Rx1)/Wy1 (Gx1Ry1−Bx1Ry1−Gy1 Rx1+By1 Rx1+Bx1Gy1−By1Gx1)); and
calculate the first blue luminance according to BL1=WL1*(By1(Rx1Wy1−Gx1Wy1−Ry1Wx1+Gy1Wx1+Gx1Ry1−Gy1 Rx1)/Wy1(Gx1Ry1−Bx1Ry1−Gy1Rx1+By1Rx1+Bx1Gy1−By1Gx1)),
where RL1 denotes the first red luminance, Rx1 denotes the first red x coordinate, Ry1 denotes the first red y coordinate, GL1 denotes the first green luminance, Gx1 denotes the first green x coordinate, Gy1 denotes the first green y coordinate, BL1 denotes the first blue luminance, Bx1 denotes the first blue x coordinate, By1 denotes the first blue y coordinate, WL1 denotes a first white luminance of the first white luminance data, Wx1 denotes the first white x coordinate, and Wy1 denotes the first white y coordinate.

5. The luminance compensating apparatus of claim 3, wherein the luminance divider is configured to:
calculate the second red luminance according to RL2=WL2*(Ry2(Gx2Wy2−Bx2Wy2−Gy2Wx2+By2Wx2+Bx2Gy2−By2Gx2)/Wy2(Gx2Ry2−Bx2Ry2−Gy2Rx2+By2Rx2+Bx2Gy2−By2Gx2));
calculate the second green luminance according to GL2=WL2*(Gy2(Rx2Wy2−Bx2Wy2−Ry2Wx2+By2Wx2+Bx2Ry2−By2Rx2)/Wy2(Gx2Ry2−Bx2Ry2−Gy2Rx2+By2Rx2+Bx2Gy2−By2Gx2)); and
calculate the second blue luminance according to BL2=WL2*(By2(Rx2Wy2−Gx2Wy2−Ry2Wx2+Gy2Wx2+Gx2Ry2−Gy2Rx2)/Wy2(Gx2Ry2−Bx2Ry2−Gy2Rx2+By2Rx2+Bx2Gy2−By2Gx2)),
where RL2 denotes the second red luminance, Rx2 denotes the second red x coordinate, Ry2 denotes the second red y coordinate, GL2 denotes the second green luminance, Gx2 denotes the second green x coordinate, Gy2 denotes the second green y coordinate, BL2 denotes the second blue luminance, Bx2 denotes the second blue x coordinate, By2 denotes the second blue y coordinate, WL2 denotes a second white luminance of the second white luminance data, Wx2 denotes the second white x coordinate, and Wy2 denotes the second white y coordinate.

6. The luminance compensating apparatus of claim 3, wherein the luminance rate calculator is configured to divide the second red luminance by the first red luminance to output a first red luminance rate, to divide the second green luminance by the first green luminance to output a first green luminance rate, and to divide the second blue luminance by the first blue luminance to output a first blue luminance rate.

7. The luminance compensating apparatus of claim 6, wherein the target luminance calculator is configured to divide the second red luminance by the first red luminance rate to output a first target red luminance, to divide the second green luminance by the first green luminance rate to output a first target green luminance, and to divide the second blue luminance by the first blue luminance rate to output a first target blue luminance.

8. The luminance compensating apparatus of claim 1, wherein the luminance rate calculator is configured to output the first luminance rate in an interpolation method utilizing first white luminances of the first white luminance data for a plurality of gray values, and first white coordinates of the first color coordinate data.

9. The luminance compensating apparatus of claim 1, wherein the color coordinate data receiver is further configured to receive third color coordinate data of a third display module,
the luminance data receiver is further configured to receive third white luminance data of the third display module,
the luminance divider is further configured to divide a third luminance of the third display module from the third color coordinate data and the third white luminance data,
the luminance rate calculator is further configured to calculate a rate of the third luminance compared to the first luminance to further output a second luminance rate,
the target luminance calculator is further configured to divide the third luminance by the second luminance rate to further output a second target luminance of the third display module, and
the luminance compensator is further configured to output second luminance compensating data for compensating the third luminance of the third display module from the second target luminance.

10. The luminance compensating apparatus of claim 9, wherein the first color coordinate data comprises a first red x coordinate, a first red y coordinate, a first green x coordinate, a first green y coordinate, a first blue x coordinate, a first blue y coordinate, a first white x coordinate, and a first white y coordinate,
the second color coordinate data comprises a second red x coordinate, a second red y coordinate, a second green x coordinate, a second green y coordinate, a second blue x coordinate, a second blue y coordinate, a second white x coordinate, and a second white y coordinate, and
the third color coordinate data comprises a third red x coordinate, a third red y coordinate, a third green x coordinate, a third green y coordinate, a third blue x coordinate, a third blue y coordinate, a third white x coordinate, and a third white y coordinate.

11. The luminance compensating apparatus of claim 10, wherein the luminance divider is configured to divide the first luminance of the first display module into a first red luminance, a first green luminance, and a first blue luminance from the first color coordinate data and the first white luminance data, to divide the second luminance of the second display module into a second red luminance, a second green luminance, and a second blue luminance from the second color coordinate data and the second white luminance data, and to divide the third luminance of the third display module into a third red luminance, a third green luminance, and a third blue luminance from the third color coordinate data and the third white luminance data.

12. The luminance compensating apparatus of claim 11, wherein the luminance divider is configured to:
calculate the first red luminance according to RL1=WL1*(Ry1(Gx1 Wy1−Bx1Wy1−Gy1Wx1+By1Wx1+Bx1Gy1−By1Gx1)/Wy1(Gx1Ry1−Bx1Ry1−Gy1 Rx1+By1Rx1+Bx1Gy1−By1Gx1));
calculate the first green luminance according to GL1=WL1*(Gy1(Rx1Wy1−Bx1Wy1−Ry1Wx1+By1Wx1+Bx1Ry1−By1Rx1)/Wy1 (Gx1Ry1−Bx1Ry1−Gy1Rx1+By1Rx1+Bx1Gy1−By1Gx1)); and
calculate the first blue luminance according to BL1=WL1*(By1(Rx1Wy1−Gx1Wy1−Ry1Wx1+Gy1Wx1+Gx1Ry1−Gy1 Rx1)/Wy1(Gx1Ry1−Bx1Ry1−Gy1 Rx1+By1Rx1+Bx1Gy1−By1Gx1)),
where RL1 denotes the first red luminance, Rx1 denotes the first red x coordinate, Ry1 denotes the first red y coordinate, GL1 denotes the first green luminance, Gx1 denotes the first green x coordinate, Gy1 denotes the first green y coordinate, BL1 denotes the first blue luminance, Bx1 denotes the first blue x coordinate, By1 denotes the first blue y coordinate, WL1 denotes a first white luminance of the first white luminance data, Wx1 denotes the first white x coordinate, and Wy1 denotes the first white y coordinate.

13. The luminance compensating apparatus of claim 11, wherein the luminance divider is configured to:
calculate the second red luminance according to RL2=WL2*(Ry2(Gx2Wy2−Bx2Wy2−Gy2Wx2+By2Wx2+Bx2Gy2−By2Gx2)/Wy2(Gx2Ry2−Bx2Ry2−Gy2Rx2+By2Rx2+Bx2Gy2−By2Gx2));
calculate the second green luminance according to GL2=WL2*(Gy2(Rx2Wy2−Bx2Wy2−Ry2Wx2+By2Wx2+Bx2Ry2−By2Rx2)/Wy2(Gx2Ry2−Bx2Ry2−Gy2Rx2+By2Rx2+Bx2Gy2−By2Gx2)); and
calculate the second blue luminance according to BL2=WL2*(By2(Rx2Wy2−Gx2Wy2−Ry2Wx2+Gy2Wx2+Gx2Ry2−Gy2Rx2)/Wy2(Gx2Ry2−Bx2Ry2−Gy2Rx2+By2Rx2+Bx2Gy2−By2Gx2)),
where RL2 denotes the second red luminance, Rx2 denotes the second red x coordinate, Ry2 denotes the second red y coordinate, GL2 denotes the second green luminance, Gx2 denotes the second green x coordinate, Gy2 denotes the second green y coordinate, BL2 denotes the second blue luminance, Bx2 denotes the second blue x coordinate, By2 denotes the second blue y coordinate, WL2 denotes a second white luminance of the second white luminance data, Wx2 denotes the second white x coordinate, and Wy2 denotes the second white y coordinate.

14. The luminance compensating apparatus of claim 11, wherein the luminance divider is configured to:
calculate the third red luminance according to RL3=WL3*(Ry3(Gx3Wy3−Bx3Wy3−Gy3Wx3+By3Wx3+Bx3Gy3−By3Gx3)/Wy3(Gx3Ry3−Bx3Ry3−Gy3Rx3+By3Rx3+Bx3Gy3−By3Gx3));
calculate the third green luminance according to GL3=WL3*(Gy3(Rx3Wy3−Bx3Wy3−Ry3Wx3+By3Wx3+Bx3Ry3−By3Rx3)/Wy3(Gx3Ry3−Bx3Ry3−Gy3Rx3+By3Rx3+Bx3Gy3−By3Gx3)); and
calculate the third blue luminance according to BL3=WL3*(By3(Rx3Wy3−Gx3Wy3−Ry3Wx3+Gy3Wx3+Gx3Ry3−Gy3Rx3)/Wy3(Gx3Ry3−Bx3Ry3−Gy3Rx3+By3Rx3+Bx3Gy3−By3Gx3)),
where RL3 denotes the third red luminance, Rx3 denotes the third red x coordinate, Ry3 denotes the third red y coordinate, GL3 denotes the third green luminance, Gx3 denotes the third green x coordinate, Gy3 denotes the third green y coordinate, BL3 denotes the third blue luminance, Bx3 denotes the third blue x coordinate, By3 denotes the third blue y coordinate, WL3 denotes a third white luminance of the third white luminance data, Wx3 denotes the third white x coordinate, and Wy3 denotes the third white y coordinate.

15. The luminance compensating apparatus of claim 11, wherein the luminance rate calculator is configured to divide the second red luminance by the first red luminance to output a first red luminance rate, to divide the second green luminance by the first green luminance to output a first green luminance rate, to divide the second blue luminance by the first blue luminance to output a first blue luminance rate, to divide the third red luminance by the first red luminance to output a second red luminance rate, to divide the third green luminance by the first green luminance to output a second green luminance rate, and to divide the third blue luminance by the first blue luminance to output a second blue luminance rate.

16. The luminance compensating apparatus of claim 15, wherein the target luminance calculator is configured to divide the second red luminance by the first red luminance rate to output a first target red luminance, to divide the second green luminance by the first green luminance rate to output a first target green luminance, to divide the second blue luminance by the first blue luminance rate to output a first target blue luminance, to divide the third red luminance by the second red luminance rate to output a second target red luminance, to divide the third green luminance by the second green luminance rate to output a second target green luminance, and to divide the third blue luminance by the second blue luminance rate to output a second target blue luminance.

17. A method of compensating a luminance, the method comprising:
receiving first color coordinate data of a first display module;
receiving second color coordinate data of a second display module;
receiving first white luminance data of the first display module;
receiving second white luminance data of the second display module;
dividing a first luminance of the first display module from the first color coordinate data and the first white luminance data;
dividing a second luminance of the second display module from the second color coordinate data and the second white luminance data;
calculating a rate of the second luminance compared to the first luminance to output a first luminance rate;
dividing the second luminance by the first luminance rate to output a first target luminance of the second display module; and
outputting first luminance compensating data for compensating the second luminance of the second display module from the first target luminance.

18. The method of claim 17, further comprising:
receiving third color coordinate data of a third display module;
receiving third white luminance data of the third display module;
dividing a third luminance of the third display module from the third color coordinate data and the third white luminance data;
calculating a rate of the third luminance compared to the first luminance to output a second luminance rate;
dividing the third luminance by the second luminance rate to output a second target luminance of the third display module; and
outputting second luminance compensating data for compensating the third luminance of the third display module from the second target luminance.

19. A display system comprising:
a display apparatus comprising a first display module and a second display module; and
a luminance compensator comprising:
a color coordinate data receiver configured to receive first color coordinate data of the first display module and second color coordinate data of the second display module;
a white luminance data receiver configured to receive first white luminance data of the first display module and second white luminance data of the second display module;
a luminance divider configured to divide a first luminance of the first display module from the first color coordinate data and the first white luminance data, and to divide a second luminance of the second display module from the second color coordinate data and the second white luminance data;
a luminance rate calculator configured to calculate a rate of the second luminance compared to the first luminance to output a first luminance rate;
a target luminance calculator configured to divide the second luminance by the first luminance rate to output a first target luminance of the second display module; and
a luminance compensator configured to output first luminance compensating data for compensating the second luminance of the second display module from the first target luminance.

20. The display system of claim 19, wherein the display apparatus further comprises a third display module,
the color coordinate data receiver is further configured to receive third color coordinate data of a third display module,
the luminance data receiver is further configured to receive third white luminance data of the third display module,
the luminance divider is further configured to divide a third luminance of the third display module from the third color coordinate data and the third white luminance data,
the luminance rate calculator is further configured to calculate a rate of the third luminance compared to the first luminance to further output a second luminance rate,
the target luminance calculator is further configured to divide the third luminance by the second luminance rate to further output a second target luminance of the third display module, and
the luminance compensator is further configured to output second luminance compensating data for compensating the third luminance of the third display module from the second target luminance.
